(19) United States
(12) Patent Application Publication
(10) Pub. No.: US 2025/0149235 A1
(43) Pub. Date: May 8, 2025

(54) STRUCTURE AND METHOD FOR MANUFACTURING STRUCTURE

(71) Applicant: FUJIFILM Corporation, Tokyo (JP)

(72) Inventor: Seiya MASUDA, Shizuoka (JP)

(73) Assignee: FUJIFILM Corporation, Tokyo (JP)

(21) Appl. No.: 19/012,205

(22) Filed: Jan. 7, 2025

Related U.S. Application Data
(63) Continuation of application No. PCT/JP2023/026525, filed on Jul. 20, 2023.

(30) Foreign Application Priority Data
Aug. 30, 2022 (JP) 2022-136830

(51) Int. Cl. H01F 27/32; H01F 1/22; H01F 41/04

(52) U.S. Cl. CPC H01F 27/323; H01F 1/22; H01F 41/04

(57) ABSTRACT

Provided are a structure having a high Q value and a small size, and a method for manufacturing a structure. The structure has a planar inductor disposed on a substrate, and further has a first magnetic body portion disposed on a substrate side with respect to the planar inductor with a first insulating layer interposed therebetween, a second magnetic body portion disposed on a side opposite to the substrate side with respect to the planar inductor with a second insulating layer interposed therebetween, and a third magnetic body portion disposed on a center portion of the planar inductor. At least a part of the first magnetic body portion, the second magnetic body portion, and the third magnetic body portion overlap with each other in a normal direction of the substrate, and the first magnetic body portion consists of a first center portion and a plurality of extending portions extending outward from the first center portion in an in-plane direction, or consists of a flat plate portion that covers at least a part of a region from a center of the planar inductor to the outside. The second magnetic body portion consists of a second center portion and a plurality of extending portions extending outward from the second center portion in an in-plane direction, or consists of a flat plate portion that covers at least a part of a region from the center of the planar inductor to the outside.

### CROSS-REFERENCE TO RELATED APPLICATIONS

This application is a Continuation of PCT International Application No. PCT/JP2023/026525 filed on Jul. 20, 2023, which claims priority under 35 U.S.C. § 119(a) to Japanese Patent Application No. 2022-136830 filed on Aug. 30, 2022. The above applications are hereby expressly incorporated by reference, in their entirety, into the present application.

### BACKGROUND OF THE INVENTION

### 1. Field of the Invention

The present invention relates to a structure having a planar inductor and a magnetic body portion, and a method for manufacturing a structure.

### 2. Description of the Related Art

Currently, a mobile communication terminal such as a mobile phone or a smartphone, and an electronic apparatus such as a personal computer use electronic components such as a central processing unit (CPU), a power amplifier, a converter, an active element, and a passive element to realize various types of processing.

For example, a planar magnetic element is proposed as the passive element in JP1997-134820A (JP-H09-134820A).

The planar magnetic element in JP1997-134820A (JP-H09-134820A) is a planar magnetic element in which one or more planar coils are sandwiched between soft magnetic bodies with an insulator interposed therebetween, with the planar coil being composed of conductor lines in which a coil conductor that forms the planar coil is divided into a plurality of parts.

### SUMMARY OF THE INVENTION

For example, a CPU, a power amplifier, and a converter require an electric power source for driving, and a planar inductor is used for removing noise from a voltage supplied by the electric power source. The planar inductor is required to have a high Q value because the performance of noise removal is excellent in a case where the Q value is high. The planar inductor is also referred to as a planar inductor.

With multifunctionalization and miniaturization of electronic apparatus in recent years, there has also been a demand for miniaturization of electronic components. There has also been a demand for miniaturization of the above-mentioned planar inductor while maintaining the performance such as the Q value.

The planar magnetic element in JP1997-134820A (JP-H09-134820A) corresponds to the above-mentioned planar inductor, but does not have a high Q value and cannot be reduced in size.

An object of the present invention is to provide a structure having a high Q value and a small size, and a method for manufacturing a structure.

The above-mentioned object can be achieved by the following configurations.

Invention [1] is a structure including a substrate and a planar inductor disposed on the substrate, in which the structure further includes a first magnetic body portion disposed on a substrate side with respect to the planar inductor with a first insulating layer interposed therebetween, a second magnetic body portion disposed on a side opposite to the substrate side with respect to the planar inductor with a second insulating layer interposed therebetween, and a third magnetic body portion disposed on a center portion of the planar inductor, at least a part of the first magnetic body portion, the second magnetic body portion, and the third magnetic body portion overlap with each other in a normal direction of the substrate, the first magnetic body portion consists of a first center portion and a plurality of extending portions extending outward from the first center portion in an in-plane direction, or consists of a flat plate portion that covers at least a part of a region from a center of the planar inductor to an outside, and the second magnetic body portion consists of a second center portion and a plurality of extending portions extending outward from the second center portion in the in-plane direction, or consists of a flat plate portion that covers at least a part of a region from the center of the planar inductor to the outside.

Invention [2] is the structure according to Invention [1], in which a magnetic permeability of each of the first magnetic body portion, the second magnetic body portion, and the third magnetic body portion is 1 to 10000 at a frequency of 10 MHz to 500 MHz, 1 to 1000 at a frequency of more than 500 MHz and 10 GHz or less, and 1 to 100 at a frequency of more than 10 GHz and 100 GHz or less.

Invention [3] is the structure according to Invention [1] or [2], in which a ratio of an area occupied by the third magnetic body portion to an area of an opening portion provided in the center portion of the planar inductor is 25% or more.

Invention [4] is the structure according to any one of Inventions [1] to [3], in which the number of the extending portions of the first magnetic body portion and the number of the extending portions of the second magnetic body portion are each 4 or more.

Invention [5] is the structure according to any one of Inventions [1] to [4], in which at least one of the first magnetic body portion, the second magnetic body portion, or the third magnetic body portion is formed of a composition containing magnetic particles, an alkali-soluble resin, and a polymerizable compound.

Invention [6] is the structure according to any one of Inventions [1] to [4], in which at least one of the first magnetic body portion, the second magnetic body portion, or the third magnetic body portion contains magnetic particles, and the magnetic particles contain at least one metal element of Ni, Co, or Fe and have an average primary particle diameter of 20 to 1000 nm.

Invention [7] is the structure according to any one of Inventions [1] to [6], in which a thickness of each of the first magnetic body portion, the second magnetic body portion, and the third magnetic body portion is 300 μm or less.

Invention [8] is a method for manufacturing the structure according to any one of Inventions [1] to [7], the method including a step of applying a photosensitive composition containing magnetic particles onto a substrate to form a composition layer; a step of subjecting the composition layer to an exposure treatment and a development treatment to form a first magnetic body portion on the substrate; a step of forming a first insulating layer on the first magnetic body portion; a step of forming a planar inductor having an opening portion on the first insulating layer; a step of applying the photosensitive composition onto the planar inductor to form a composition layer, and subjecting the composition layer to an exposure treatment and a development treatment to form a third magnetic body portion in the opening portion of the planar inductor; a step of forming a second insulating layer on the planar inductor; and a step of applying the photosensitive composition onto the second insulating layer formed on the planar inductor to form a composition layer, and subjecting the composition layer to an exposure treatment and a development treatment to form a second magnetic body portion.

Invention [9] is a method for manufacturing the structure according to any one of Inventions [1] to [7], the method including a step of applying a curable composition containing magnetic particles in a patterned manner onto a substrate to form a first patterned composition layer, and subjecting the first patterned composition layer to a curing treatment to form a first magnetic body portion; a step of forming a first insulating layer on the first magnetic body portion; a step of forming a planar inductor having an opening portion on the insulating layer; a step of applying the curable composition in a patterned manner onto the opening portion of the planar inductor to form a third patterned composition layer, and subjecting the third patterned composition layer to a curing treatment to form a third magnetic body portion; a step of forming a second insulating layer on the planar inductor; and a step of applying the curable composition in a patterned manner onto the second insulating layer formed on the planar inductor to form a second patterned composition layer, and subjecting the second patterned composition layer to a curing treatment to form a second magnetic body portion.

Invention [10] is the method for manufacturing a structure according to Invention [8] or [9], in which the magnetic particles contain at least one metal element of Ni, Co, or Fe and have an average primary particle diameter of 20 to 1000 nm.

According to the present invention, it is possible to provide a structure having a high Q value and a small size, and a method for manufacturing the same.

### BRIEF DESCRIPTION OF THE DRAWINGS

FIG. 1 is a schematic cross-sectional view showing a first example of a structure according to an embodiment of the present invention.

FIG. 2 is a schematic perspective view showing an example of a planar inductor used in the first example of the structure according to the embodiment of the present invention.

FIG. 3 is a schematic view showing an example of a measurement result of the structure according to the embodiment of the present invention.

FIG. 4 is a schematic cross-sectional view showing an example of a method for manufacturing the first example of the structure according to the embodiment of the present invention.

FIG. 5 is a schematic cross-sectional view showing an example of a method for manufacturing the first example of the structure according to the embodiment of the present invention.

FIG. 6 is a schematic cross-sectional view showing an example of a method for manufacturing the first example of the structure according to the embodiment of the present invention.

FIG. 7 is a schematic cross-sectional view showing an example of a method for manufacturing the first example of the structure according to the embodiment of the present invention.

FIG. 8 is a schematic cross-sectional view showing an example of a method for manufacturing the first example of the structure according to the embodiment of the present invention.

FIG. 9 is a schematic cross-sectional view showing an example of a method for manufacturing the first example of the structure according to the embodiment of the present invention.

FIG. 10 is a schematic cross-sectional view showing an example of a method for manufacturing the first example of the structure according to the embodiment of the present invention.

FIG. 11 is a schematic cross-sectional view showing an example of a method for manufacturing the first example of the structure according to the embodiment of the present invention.

FIG. 12 is a schematic cross-sectional view showing an example of a method for manufacturing the first example of the structure according to the embodiment of the present invention.

FIG. 13 is a schematic cross-sectional view showing an example of a method for manufacturing the first example of the structure according to the embodiment of the present invention.

FIG. 14 is a schematic cross-sectional view showing an example of a method for manufacturing the first example of the structure according to the embodiment of the present invention.

FIG. 15 is a schematic cross-sectional view showing an example of a method for manufacturing the first example of the structure according to the embodiment of the present invention.

FIG. 16 is a schematic cross-sectional view showing an example of a method for manufacturing the first example of the structure according to the embodiment of the present invention.

FIG. 17 is a schematic cross-sectional view showing an example of a method for manufacturing the first example of the structure according to the embodiment of the present invention.

FIG. 18 is a schematic cross-sectional view showing an example of a method for manufacturing the first example of the structure according to the embodiment of the present invention.

FIG. 19 is a schematic cross-sectional view showing an example of a method for manufacturing the first example of the structure according to the embodiment of the present invention.

FIG. 20 is a schematic perspective view showing a second example of the structure according to the embodiment of the present invention.

FIG. 21 is a schematic side view showing the second example of the structure according to the embodiment of the present invention.

FIG. 22 is a schematic perspective view showing a third example of the structure according to the embodiment of the present invention.

FIG. 23 is a schematic perspective view showing a fourth example of the structure according to the embodiment of the present invention.

FIG. 24 is a schematic perspective view showing a fifth example of the structure according to the embodiment of the present invention.

FIG. 25 is a schematic perspective view showing a sixth example of the structure according to the embodiment of the present invention.

FIG. 26 is a schematic perspective view showing a seventh example of the structure according to the embodiment of the present invention.

FIG. 27 is a schematic perspective view showing an eighth example of the structure according to the embodiment of the present invention.

FIG. 28 is a schematic perspective view showing a ninth example of the structure according to the embodiment of the present invention.

FIG. 29 is a schematic perspective view showing a tenth example of the structure according to the embodiment of the present invention.

FIG. 30 is a schematic perspective view showing an eleventh example of the structure according to the embodiment of the present invention.

FIG. 31 is a schematic perspective view showing a twelfth example of the structure according to the embodiment of the present invention.

FIG. 32 is a schematic perspective view showing a thirteenth example of the structure according to the embodiment of the present invention.

FIG. 33 is a schematic perspective view showing a fourteenth example of the structure according to the embodiment of the present invention.

FIG. 34 is a schematic perspective view showing a fifteenth example of the structure according to the embodiment of the present invention.

FIG. 35 is a schematic perspective view showing a sixteenth example of the structure according to the embodiment of the present invention.

FIG. 36 is a schematic perspective view showing a structure of Comparative Example 2.

FIG. 37 is a schematic perspective view showing a structure of Comparative Example 3.

FIG. 38 is a schematic perspective view showing a structure of Comparative Example 8.

FIG. 39 is a schematic perspective view showing a structure of Comparative Example 9.

FIG. 40 is a schematic perspective view showing a structure of Comparative Example 10.

FIG. 41 is a schematic perspective view showing a structure of Comparative Example 11.

### DESCRIPTION OF THE PREFERRED EMBODIMENTS

Hereinafter, a structure and a method for manufacturing a structure according to the embodiment of the present invention will be described in detail with reference to suitable embodiments shown in the accompanying drawings.

It should be noted that the drawings described below are only illustrative for explaining the present invention, and the present invention is not limited to the drawings shown below.

In addition, the drawings described below are drawings in which a portion of a planar inductor and portions of a first magnetic body portion, a second magnetic body portion, and a third magnetic body portion in an actual device are emphasized, and illustrations of an electric circuit, a copper wire, a waveguide, and the like around the planar inductor are omitted.

In the following, the expression “to” indicating a numerical range includes numerical values written on both sides of “to”. For example, in a case where F is a value between a numerical value ε_{α} and a numerical value ε_{β}, the range of F is a range including the numerical value Fa and the numerical value ε_{β} and is expressed by εₐ≤ε≤ε_{β} in mathematical symbols.

Unless otherwise specified, angles include an error range generally acceptable in the relevant technical field.

### First Example of Structure

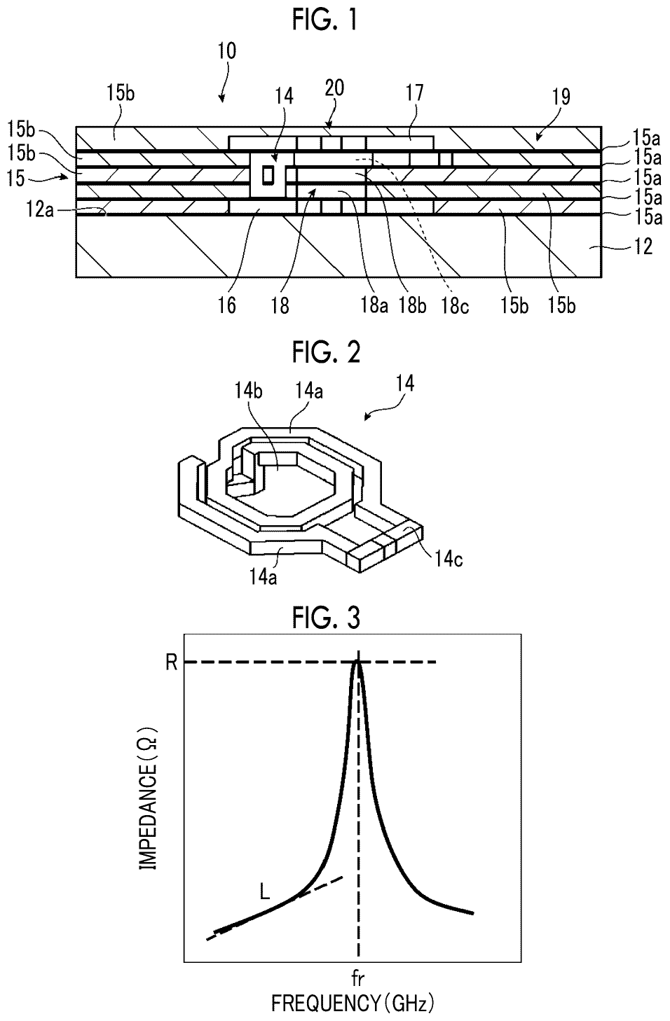

FIG. 1 is a schematic cross-sectional view showing a first example of the structure according to the embodiment of the present invention, and FIG. 2 is a schematic perspective view showing an example of a planar inductor used in the first example of the structure according to the embodiment of the present invention.

As shown in FIG. 1, a structure 10 includes a substrate 12 and a planar inductor 14 disposed on the substrate 12.

In the structure 10, a first magnetic body portion 16 is disposed on the substrate 12 side with respect to the planar inductor 14 with a first insulating layer 15 interposed therebetween. The first insulating layer 15 provided on a surface 12a of the substrate 12 is an electrical insulating film. The first insulating layer 15 includes, for example, a shield insulating layer 15a and an interlayer insulating layer 15b. The first insulating layer 15 is configured such that the shield insulating layer 15a and the interlayer insulating layer 15b are laminated in this order from the substrate 12 side. In the first insulating layer 15, the number of laminated layers of the shield insulating layers 15a and the interlayer insulating layers 15b is four layers in FIG. 1, but is not particularly limited.

The first magnetic body portion 16 is disposed between the shield insulating layer 15a provided on the surface 12a of the substrate 12 and the shield insulating layer 15a disposed on the interlayer insulating layer 15b on the substrate 12 side. The first magnetic body portion 16 is embedded in the interlayer insulating layer 15b.

The shield insulating layer 15a provides electrical insulation while suppressing diffusion of the material constituting the planar inductor 14 and the materials constituting the first magnetic body portion 16, a second magnetic body portion 17, and a third magnetic body portion 18. The interlayer insulating layer 15b is thicker than the shield insulating layer 15a and provides electrical insulation over a large range.

The second magnetic body portion 17 is disposed on a side opposite to the substrate 12 side with respect to the planar inductor 14 with a second insulating layer 19 interposed therebetween. The second insulating layer 19 is an electrical insulating film, and includes a shield insulating layer 15a and an interlayer insulating layer 15b, similarly to the first insulating layer 15. The shield insulating layer 15a is provided between the planar inductor 14 and the second magnetic body portion 17. The second magnetic body portion 17 is embedded in the interlayer insulating layer 15b of the second insulating layer 19.

The first magnetic body portion 16 and the third magnetic body portion 18 are electrically insulated from the planar inductor 14 by the first insulating layer 15. In addition, the first magnetic body portion 16 and the third magnetic body portion 18 are electrically insulated from each other by the first insulating layer 15, that is, the laminated shield insulating layer 15a and interlayer insulating layer 15b. The second magnetic body portion 17 and the planar inductor 14 are electrically insulated from each other by the second insulating layer 19.

The third magnetic body portion 18 shown in FIG. 1 is composed of, for example, three magnetic bodies 18a, 18b, and 18c. The three magnetic bodies 18a, 18b, and 18c are, for example, all of the same polygonal or disc shape, and have the same size. Among the three magnetic bodies 18a, 18b, and 18c, the magnetic body 18c is disposed in an opening portion 14b (see FIG. 2) of the planar inductor 14. All of the three magnetic bodies 18a, 18b, and 18c are sandwiched between the shield insulating layers 15a and embedded in the interlayer insulating layers 15b. As a result, the three magnetic bodies 18a, 18b, and 18c are electrically insulated from one another.

In FIG. 1, the third magnetic body portion 18 is composed of three magnetic bodies 18a, 18b, and 18c, but the number of magnetic bodies constituting the third magnetic body portion 18 is not particularly limited.

The first magnetic body portion 16, the second magnetic body portion 17, and the third magnetic body portion 18 are collectively referred to simply as a magnetic body portion 20.

The planar inductor 14 is a passive element. The planar inductor 14 is, for example, a coil as shown in FIG. 2 and is composed of, for example, a strip-shaped member 14a having a predetermined number of turns.

The planar inductor 14 has, for example, a circular outer shape or a polygonal outer shape such as an octagon. The planar inductor 14 has the opening portion 14b that is open with respect to the surface 12a of the substrate 12. The opening portion 14b of the planar inductor 14 is a region surrounded by the strip-shaped member 14a.

The strip-shaped member 14a of the planar inductor 14 is provided with a power supply port 14c. The two strip-shaped members 14a are electrically connected to the power supply port 14c. A voltage is applied to the planar inductor 14 through the power supply port 14c.

The coil shown by the planar inductor 14 can be used alone as an inductor. The planar inductor 14 is used, for example, to remove noise of a voltage. For example, a voltage after removing noise by passing a voltage through the planar inductor 14 is supplied to the CPU. This makes it possible to suppress the malfunction of the CPU.

The planar inductor 14 is disposed on the substrate 12 together with the magnetic body portion 20 described above.

The planar inductor 14 is composed of, for example, copper. The planar inductor 14 has, for example, an outer diameter of 5 to 1000 μm, a width of the strip-shaped member 14a of 0.5 to 500 μm, a thickness of the strip-shaped member 14a of 0.05 to 100 μm, and the number of turns of the strip-shaped member 14a of 1 to 10.

Preferably, the planar inductor 14 has an outer diameter of 10 to 300 μm, a width of the strip-shaped member 14a of 2 to 100 μm, a thickness of the strip-shaped member 14a of 0.5 to 50 μm, and the number of turns of the strip-shaped member 14a of 1 to 5.

In the structure 10, at least a part of the first magnetic body portion 16, the second magnetic body portion 17, and the third magnetic body portion 18 overlap with each other in a normal direction of the substrate 12.

The first magnetic body portion 16 and the second magnetic body portion 17 each consist of a flat plate portion that covers at least a part of a region from the center of the planar inductor 14 to the outside. The center of the planar inductor 14 is a geometric center of the opening portion 14b. In addition, for example, the first magnetic body portion 16 and the second magnetic body portion 17 have a congruent shape relationship.

In addition, the positions of the first magnetic body portion 16 and the second magnetic body portion 17 relative to the third magnetic body portion 18 are also the same in the normal direction of the substrate 12 of the structure 10, that is, in a case of being viewed from a direction perpendicular to the surface 12a of the substrate 12. In this case, the outer shape of the first magnetic body portion 16 and the outer shape of the second magnetic body portion 17 overlap with each other upon being viewed from a direction perpendicular to the surface 12a of the substrate 12. This is preferable because a large number of magnetic lines generated at the opening portion 14b of the planar inductor 14 pass through the first magnetic body portion 16 and the second magnetic body portion 17, so leakage magnetism is further suppressed.

The substrate 12 is composed of, for example, Si, polyimide, or SiO₂.

The shield insulating layer 15a and the interlayer insulating layer 15b constituting the first insulating layer 15 and the second insulating layer 19 are not particularly limited as long as the shield insulating layer 15a and the interlayer insulating layer 15b have electrical insulating properties, and are composed of, for example, SiN, TiN, SiO₂, tetraethoxysilane (TEOS), and borophosphosilicate glass (BPSG). In addition, the substrate 12, the first insulating layer 15, and the second insulating layer 19 can also be composed of a glass epoxy resin such as flame retardant (FR)-4, polytetrafluoroethylene (PTFE), or the like.

The shield insulating layer 15a and the interlayer insulating layer 15b constituting the first insulating layer 15 and the second insulating layer 19 are different from the magnetic body portion 20. It is preferable that the magnetic permeability of the shield insulating layer 15a and the interlayer insulating layer 15b constituting the first insulating layer 15 and the second insulating layer 19 does not satisfy the following requirements 1 to 3.
Requirement 1: the magnetic permeability at a frequency of 10 MHz to 500 MHz is 1 to 10000
Requirement 2: the magnetic permeability at a frequency of more than 500 MHz and 10 GHz or less is 1 to 1000
Requirement 3: the magnetic permeability at a frequency of more than 10 GHz and 100 GHz or less is 1 to 100

The structure 10 is used, for example, in an antenna-in-package, and is provided with, for example, an array antenna, an A/D circuit, a memory, and an application specific integrated circuit (ASIC), which are not shown, in addition to the above-mentioned planar inductor 14. The A/D circuit, memory, and ASIC are composed of, for example, various semiconductor elements.

In addition, the structure 10 has, in addition to the above-mentioned configuration, various circuits, elements, and the like that a mobile communication terminal such as a smartphone or a wireless communication module has, for example, a radio frequency (RF) circuit, a power amplifier for transmission, a low noise amplifier for reception, an integrated passive element, a switch, and a phase shifter.

The substrate 12 functions as a support for the structure 10, and the above-mentioned planar inductor 14 is disposed thereon. In addition, the magnetic body portion 20 is disposed on the substrate 12. In addition, the A/D circuit, memory, ASIC, and the like constituting the above-mentioned antenna-in-package may be disposed on the substrate 12.

The first insulating layer 15 and the second insulating layer 19 are on which the planar inductor 14 and the magnetic body portion 20 are formed, and keep the planar inductor 14 and the magnetic body portion 20 in an electrically insulated state.

The first insulating layer 15 and the second insulating layer 19 are not particularly limited as long as the first insulating layer 15 and the second insulating layer 19 can electrically insulate the planar inductor 14 and the magnetic body portion 20, and various layers used in the formation of a semiconductor element or the like can be used.

The first magnetic body portion 16, the second magnetic body portion 17, and the third magnetic body portion 18 increase the inductance of the planar inductor 14, thereby increasing the Q value and reducing the size.

A large number of magnetic lines generated at the opening portion 14b of the planar inductor 14 pass through the first magnetic body portion 16 and the second magnetic body portion 17, thereby suppressing the leakage magnetic flux and increasing the inductance of the planar inductor 14. For this reason, it is preferable that the first magnetic body portion 16 and the second magnetic body portion 17 are configured such that a large number of magnetic lines pass through or are disposed such that a large number of magnetic lines pass through. The leakage magnetic flux is suppressed, so the effect of magnetic force on other electronic components can be suppressed. As a result, the normal operation of electronic components is also suppressed from being hindered.

The third magnetic body portion 18 increases the inductance of the planar inductor 14 and increases the Q value. As a result, the planar inductor 14 can be made smaller.

Generally, the planar inductor 14 has a high inductance in a case where a magnetic body is present. In a case where the size ratio between the coil (the region surrounded by the strip-shaped member 14a) and the magnetic body is kept constant and the coil (the region surrounded by the strip-shaped member 14a) is reduced in size, the inductance decreases and eventually reaches the same inductance value as in a case where there is no magnetic body. Therefore, it is possible to calculate the change in size of the coil (the region surrounded by the strip-shaped member 14a) through simulation to thereby calculate the approximate reducible rate of the designed inductor.

In addition, similarly, the resonance frequency of the planar inductor 14 also decreases in a case where there is a magnetic body. In a case where the size ratio between the coil (the region surrounded by the strip-shaped member 14a) and the magnetic body are kept constant and the coil (the region surrounded by the strip-shaped member 14a) is reduced in size, the resonance frequency shifts to a higher frequency side and eventually reaches the same resonance frequency as in a case where there is no magnetic body. Therefore, it is possible to calculate the change in size of the coil (the region surrounded by the strip-shaped member 14a) through simulation to thereby calculate the approximate reduction rate of the designed inductor.

In the planar inductor 14, the arrangement of the magnetic body that can reduce the size of the inductor allows the coil (the region surrounded by the strip-shaped member 14a) to be reduced to a size of approximately 70% to 50%, so it is preferable that the inductance ratio described later is 1.1 or more and the resonance frequency ratio described later is 0.75 or less, and it is more preferable that the inductance ratio described later is more than 1.5 and the resonance frequency ratio described later is less than 0.65.

Here, with regard to the resonance frequency, the change in electromagnetic field of the planar inductor 14 in a case where a voltage of 1 V is applied to a power supply port 14c of the planar inductor 14 and the frequency is changed from 100 MHz to 1000 GHz is calculated. The generated magnetic lines are deformed along a magnetic body in a case where the magnetic body is present.

From the obtained graph of the resonance frequency shown in FIG. 3, the inclination of the slope in the low frequency region is taken as inductance L (H), and the maximum value of the peak of the impedance is taken as R (Ω). The frequency at the peak of the impedance is taken as the resonance frequency fr (Hz). The capacitance C (F) is calculated from these numerical values according to the following expression. The Q value is calculated according to the following expression using R, L, and C.

$$C = \frac{1}{4 {π}^{2} {fr}^{2} L}$$

$$Q = R \sqrt{\frac{C}{L}}$$

By measuring the value L0 of the inductance in a state where there is no magnetic body portion and the resonance frequency fr0 in a state where there is no magnetic body portion, the changes in inductance and resonance frequency due to the magnetic body portion can be found.

As the inductance ratio represented by L/L0 is larger and the resonance frequency ratio represented by fr/fr0 is smaller, the size of the opening portion 14b of the planar inductor 14 can be reduced.

L is a value of inductance in a state where there is a magnetic body portion. fr is a resonance frequency in a state where there is a magnetic body portion.

For example, it is preferable that at least one of the first magnetic body portion 16, the second magnetic body portion 17, or the third magnetic body portion 18 (for example, three magnetic bodies 18a, 18b, and 18c) is formed of a composition containing magnetic particles, an alkali-soluble resin, and a polymerizable compound.

In addition, for example, it is preferable that at least one of the first magnetic body portion 16, the second magnetic body portion 17, or the third magnetic body portion 18 (for example, three magnetic bodies 18a, 18b, and 18c) contains magnetic particles, and the magnetic particles contain at least one metal element of Ni, Co, or Fe and have an average primary particle diameter of 20 to 1000 nm.

It is preferable that the magnetic permeability of each of the first magnetic body portion 16, the second magnetic body portion 17, and the third magnetic body portion 18 (for example, three magnetic bodies 18a, 18b, and 18c) is 1 to 10000 at a frequency of 10 MHz to 500 MHz, 1 to 1000 at a frequency of more than 500 MHz and 10 GHz or less, and 1 to 100 at a frequency of more than 10 GHz and 100 GHz or less.

In a case where the magnetic permeability of each of the first magnetic body portion 16, the second magnetic body portion 17, and the third magnetic body portion 18 (for example, three magnetic bodies 18a, 18b, and 18c) is 1 to 10000 at a frequency of 10 MHz to 500 MHz, 1 to 1000 at a frequency of more than 500 MHz and 10 GHz or less, and 1 to 100 at a frequency of more than 10 GHz and 100 GHz or less, the Q value of the planar inductor 14 can be increased and the size of the planar inductor 14 can be reduced as described above.

The magnetic permeability of each of the first magnetic body portion, the second magnetic body portion, and the third magnetic body portion (for example, three magnetic bodies 18a, 18b, and 18c) is measured by a high-frequency magnetic permeability measuring device (Model No. PER01, manufactured by KEYCOM Corporation). The magnetic permeability of each of the shield insulating layer 15a and the interlayer insulating layer 15b constituting the first insulating layer 15 and the second insulating layer 19 can also be measured in the same manner as the magnetic permeability of each of the first magnetic body portion 16, the second magnetic body portion 17, and the third magnetic body portion 18 as described above.

The insulator does not have the performance of the magnetic body, so the result is a value of 1 even in a case of calculation. From this, the magnetic permeability of each of the shield insulating layer 15a and the interlayer insulating layer 15b constituting the first insulating layer 15 and the second insulating layer 19 is calculated to be 1.

The magnetic permeability is a rate of change of a magnetic flux density (B) that occurs in a case where a magnetic field (H) is applied to a certain material, and is expressed by the following expression.

$$μ = B / H$$

In a case of a magnetic body, a larger amount of magnetic flux is passed through the inside of the magnetic body, but a material that is not a magnetic body exhibits no change in magnetic flux, so the value of magnetic permeability is 1. The complex relative magnetic permeability μ is expressed by the following expression. Here, j in the following expression represents an imaginary number. The real part μ′ of the complex relative magnetic permeability μ is the magnetic permeability of the present invention.

$$μ = {μ}^{′} ( real part ) - j \times {μ}^{″} ( imaginary part )$$

In a case where the direction of the current is reversed at a high-frequency wave such as an electromagnetic wave, the real part means the performance as a magnetic body that produces a higher magnetic flux density, whereas μ″ of the imaginary part represents an energy loss. Specifically, the magnetic moment of the crystals in the magnetic body tends to orient in the direction of the magnetic field generated by a high-frequency wave, but in a case where the magnetic moment is reversed in an opposite direction, a delay in the reversal time or an energy loss (as heat) occurs.

In addition, the thickness of each of the first magnetic body portion 16, the second magnetic body portion 17, and the third magnetic body portion 18 is preferably 300 μm or less. In a case where the thickness of each of the first magnetic body portion 16, the second magnetic body portion 17, and the third magnetic body portion 18 is 300 μm or less, the Q value can be increased and the height of the structure can be reduced.

The thickness of each of the first magnetic body portion 16, the second magnetic body portion 17, and the third magnetic body portion 18 is more preferably 10 to 200 μm, and the lower limit value of the thickness is 5 μm.

The thickness of the third magnetic body portion 18 refers to a thickness of each of the three magnetic bodies 18a, 18b, and 18c constituting the third magnetic body portion 18.

The ratio of an area occupied by the third magnetic body portion 18 to an area of the opening portion 14b provided in the center portion of the planar inductor 14 is preferably 25% or more, more preferably 50% or more, and still more preferably 60% or more. The upper limit value of the ratio of the area occupied by the third magnetic body portion 18 is 99.9%.

The ratio (%) of the area occupied by the third magnetic body portion 18 refers to a percentage of the area of the opening portion 14b filled with the third magnetic body portion 18 with respect to the area of the opening portion 14b of the planar inductor 14, with the area of the opening portion 14b of the planar inductor 14 being 100%. That is, it is the area of the magnetic body 18c disposed in the opening portion 14b.

For example, the area of the opening portion 14b of the planar inductor 14 and the area of the third magnetic body portion 18 in the opening portion 14b may be actual measured values or may be values obtained from computer aided design (CAD) data used for design.

The antenna-in-package has a configuration in which an antenna and a front end module (FEM) are laminated. The FEM is an arithmetic circuit portion of a wireless circuit that includes a complementary metal oxide semiconductor (CMOS) transistor that controls transmission and reception on the antenna side.

The array antenna constituting the antenna-in-package has, for example, four antennas. For example, the four antennas are all the same. The configurations of the array antenna and the antenna are not particularly limited and are appropriately determined depending on the frequency band to be transmitted or received, the direction of polarization to be received, and the like. In addition, the array antenna has four antennas, but the configuration of the array antenna is not limited thereto. Instead of an array antenna, a single antenna may be used.

The A/D circuit converts an analog signal into a digital signal, and a known A-D converter is used. The A/D circuit converts the received signal received by the array antenna through radio waves into a digital signal.

The ASIC obtains the original data or signal transmitted to the array antenna from the received signal converted into a digital signal. In addition, the ASIC generates transmission data or a transmission signal in a state of a digital signal. The functions of the ASIC are not particularly limited and are appropriately determined depending on the intended use and the like.

In addition, the A/D circuit converts the transmission data or the transmission signal generated by the ASIC into an analog signal that can be transmitted by the array antenna.

The memory stores the transmission data or the transmission signal generated in the ASIC, the received signal converted into a digital signal received by the array antenna, and the like. The memory used may be, for example, a volatile memory such as a dynamic random access memory (DRAM), and is preferably a high bandwidth memory (HBM).

### [Method for Manufacturing First Example of Structure]

The method for manufacturing the above-mentioned structure 10 shown in FIG. 1 will be described.

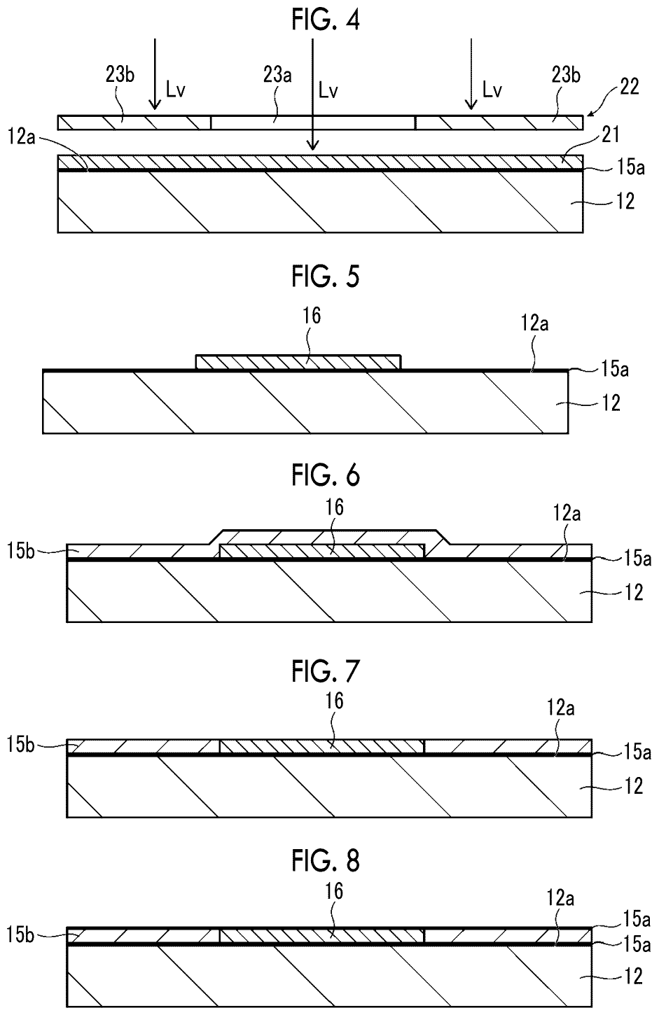

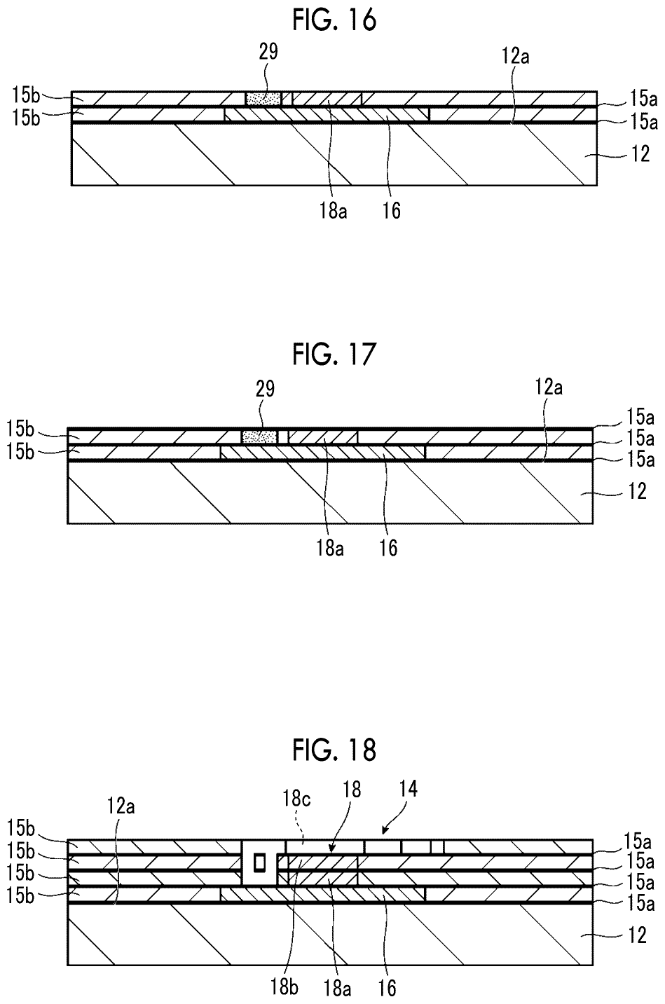

Here, FIG. 4 to FIG. 19 are schematic cross-sectional views showing an example of the method for manufacturing the first example of the structure according to the embodiment of the present invention in the order of steps. In FIG. 4 to FIG. 19, the same components as those of the structure 10 shown in FIG. 1 are denoted by the same reference numerals, and the detailed description thereof will be omitted.

For example, as shown in FIG. 4, the shield insulating layer 15a having a thickness of 50 nm to 300 nm is formed on the entire surface 12a of the substrate 12 by, for example, physical vapor deposition (PVD) or chemical vapor deposition (CVD). The shield insulating layer 15a is composed of, for example, SiN or TiN.

Next, a photosensitive composition containing magnetic particles is applied onto the entire surface of the shield insulating layer 15a to form a composition layer 21. For example, the composition layer 21 is of a negative type, and a non-exposed portion is removed by a development treatment. The thickness of the composition layer 21 is not particularly limited, and may be a thickness such that the thickness is 300 μm or less in a case of being formed into the first magnetic body portion 16 as described later.

Next, a photo mask 22 is disposed on the composition layer 21 as shown in FIG. 4. In the photo mask 22, for example, a mask portion 23b is provided in a region other than the region where the first magnetic body portion 16 is formed. A region 23a other than the mask portion 23b transmits the exposure light Lv that exposes the composition layer 21. The mask portion 23b blocks the exposure light Lv.

The composition layer 21 exposed to light using the photo mask 22 is of a negative type as described above, and a non-exposed portion is removed by a development treatment. That is, an exposed portion of the composition layer 21 is the first magnetic body portion 16.

In a case where the composition layer 21 is of a positive type, an exposed portion is removed by a development treatment, so that the light shielding region of the photo mask 22 is opposite to that of the photo mask 22 shown in FIG. 4.

The method of the development treatment is not particularly limited, and a known development treatment can be applied. Examples of the developer used in the development treatment include an alkali developer and a developer containing an organic solvent.

The planar inductor 14 is formed, for example, by a device nanofabrication technique in which steps such as lamination sputtering, physical vapor deposition (PVD), chemical vapor deposition (CVD), photolithography, dry etching, wet etching, plasma ashing, copper electrolytic plating, and chemical mechanical polishing (CMP) slurry polishing are combined a plurality of times.

In addition, the planar inductor 14 can also be formed using an insulating magnetic film.

A photosensitive magnetic body is applied onto the first insulating layer 15 to form a composition layer.

Next, the composition layer is subjected to exposure through a photo mask having a predetermined opening portion and then a development treatment to form a magnetic pattern having a predetermined shape.

Next, for example, a Ni film and a Cu film are formed as plating seed layers on the magnetic pattern by vapor deposition. Then, a photoresist film is formed in a patterned manner on the plating seed layer except for the portion where the planar inductor is formed, and then plating is grown in the opening portion of the resist by an electrolytic plating method. Thereafter, the photoresist film is peeled off, and the plating seed layer in the region covered by the photoresist film is removed by a wet etching method. After formation of a SiO₂ layer on the magnetic pattern, a Cu layer on the second stage is formed by a photolithography method, and then a photosensitive magnetic body is formed on the inside of the coil by a photolithography method. These steps are repeated to form Cu layers and magnetic body layers, thereby forming the planar inductor 14.

The photo mask 22 is disposed on the composition layer 21 which is then subjected to exposure and a development treatment to form the first magnetic body portion 16 as shown in FIG. 5.

Next, as shown in FIG. 6, the interlayer insulating layer 15b covering the first magnetic body portion 16 is formed on the entire surface 12a of the substrate 12.

The interlayer insulating layer 15b is formed by, for example, physical vapor deposition (PVD) or chemical vapor deposition (CVD). As described above, the interlayer insulating layer 15b is composed of, for example, TEOS or BPSG.

Next, as shown in FIG. 7, the interlayer insulating layer 15b is flattened by an etch-back or chemical mechanical polishing (CMP) process.

After flattening of the interlayer insulating layer 15b, the shield insulating layer 15a is formed on the entire surface of the interlayer insulating layer 15b as shown in FIG. 8. The method for forming the shield insulating layer 15a is as described above.

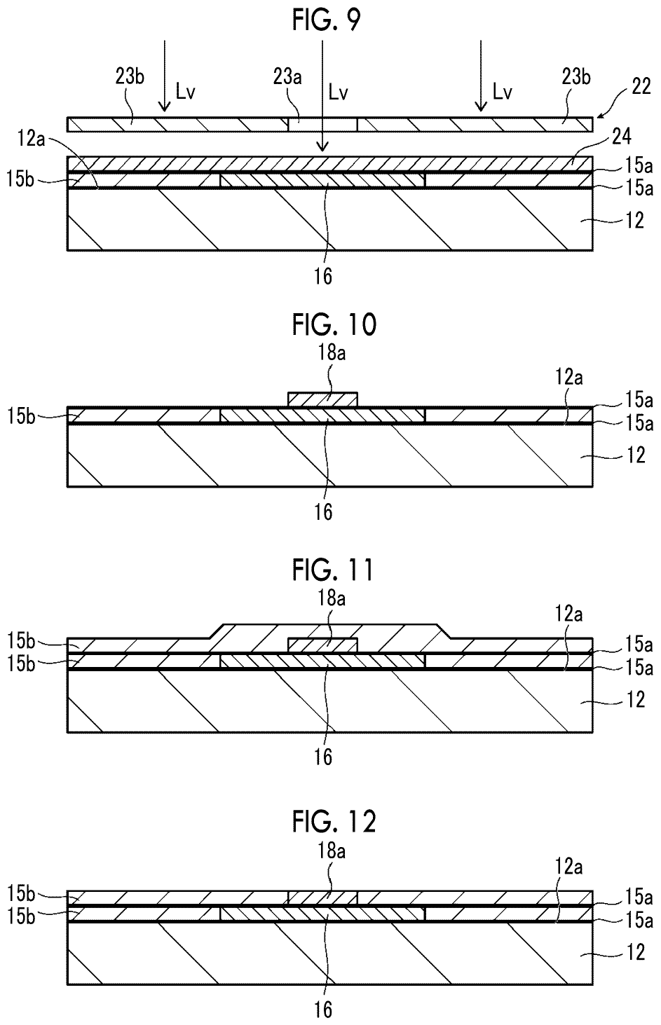

Next, a composition layer 24 is formed on the entire surface of the shield insulating layer 15a as shown in FIG. 9. The method for forming the composition layer 24 is the same as the method for forming the composition layer 21.

The photo mask 22 is disposed on the composition layer 24. In the photo mask 22, the mask portion 23b is provided in a region other than the region where the magnetic body 18a of the third magnetic body portion 18 is formed. The region 23a of the photo mask 22 transmits the exposure light Lv that exposes the composition layer 24, and the mask portion 23b blocks the exposure light Lv. The exposed portion of the composition layer 24 is the magnetic body 18a (see FIG. 10). In this manner, the magnetic body 18a is formed by the photolithography method.

After formation of the magnetic body 18a shown in FIG. 10, the interlayer insulating layer 15b that covers the magnetic body 18a is formed on the shield insulating layer 15a as shown in FIG. 11. The method for forming the interlayer insulating layer 15b is as described above.

Next, as shown in FIG. 12, a flattening treatment is carried out on the interlayer insulating layer 15b. For example, etch-back or CMP is used for the flattening treatment.

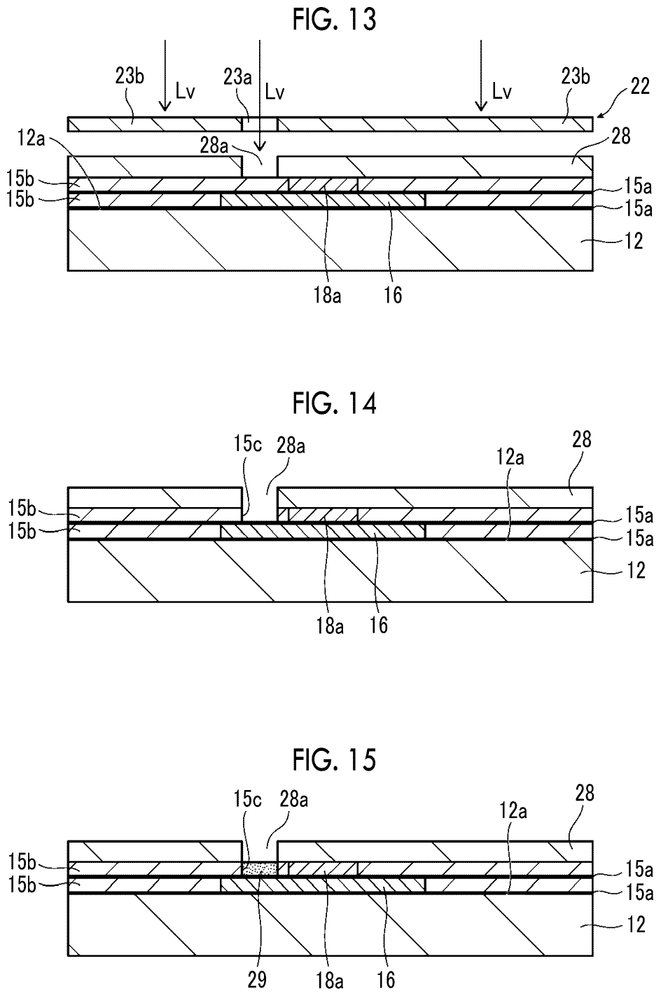

Next, a resist film 28 (see FIG. 13) is formed on the interlayer insulating layer 15b, and the photo mask 22 is disposed on the resist film 28 as shown in FIG. 13. The region 23a of the photo mask 22 transmits the exposure light Lv that exposes the resist film 28. The resist film 28 is subjected to pattern exposure using the photo mask 22 and is then developed to form an opening portion 28a in the resist film 28. The resist film 28 in FIG. 14 is of a positive type, and the exposed portion is removed by a development treatment. That is, the exposed portion is the opening portion 28a. A known photolithography method is used for the formation of the resist film 28 and the formation of the opening portion 28a of the resist film 28.

Next, the interlayer insulating layer 15b provided with the resist film 28 as shown in FIG. 13 is etched to form an opening portion 15c in the interlayer insulating layer 15b reaching the underlying shield insulating layer 15a as shown in FIG. 14. In this case, the shield insulating layer 15a under the interlayer insulating layer 15b is not etched. The etching of the interlayer insulating layer 15b is not particularly limited and may be wet etching or dry etching.

Next, as shown in FIG. 15, a metal layer 29 constituting the planar inductor 14 is formed in the opening portion 15c by, for example, electrolytic plating.

Next, the resist film 28 shown in FIG. 15 is peeled off. The method for peeling off the resist film 28 is not particularly limited. Examples of the method for peeling off the resist film 28 include peeling off the resist film 28 by ashing and peeling off the resist film 28 using a chemical liquid.

After the resist film 28 is peeled off, the interlayer insulating layer 15b on which the metal layer 29 is formed is subjected to a flattening treatment. For example, etch-back or CMP is used for the flattening treatment.

Next, after the flattening treatment, the shield insulating layer 15a shown in FIG. 17 is formed on the entire surface of the interlayer insulating layer 15b on which the metal layer 29 is formed. The method for forming the shield insulating layer 15a is as described above.

The same steps as those shown in FIG. 9 to FIG. 16 described above are repeatedly carried out. As a result, as shown in FIG. 18, for example, the magnetic bodies 18a, 18b, and 18c and the planar inductor 14 can be formed in the first insulating layer 15 that is composed of four shield insulating layers 15a and four interlayer insulating layers 15b. The planar inductor 14 is formed by laminating the metal layer 29 and the like, and has a configuration in which the shield insulating layer 15a and the interlayer insulating layer 15b are not disposed between the metal layers 29. Therefore, the planar inductor 14 has a configuration with no electrically insulated portion.

Next, as shown in FIG. 18, after formation of the magnetic bodies 18a, 18b, and 18c and the planar inductor 14 in the first insulating layer 15, the shield insulating layer 15a (not shown) is formed on the planar inductor 14 and on the entire surface of the interlayer insulating layer 15b around the planar inductor 14. The method for forming the shield insulating layer 15a is as described above.

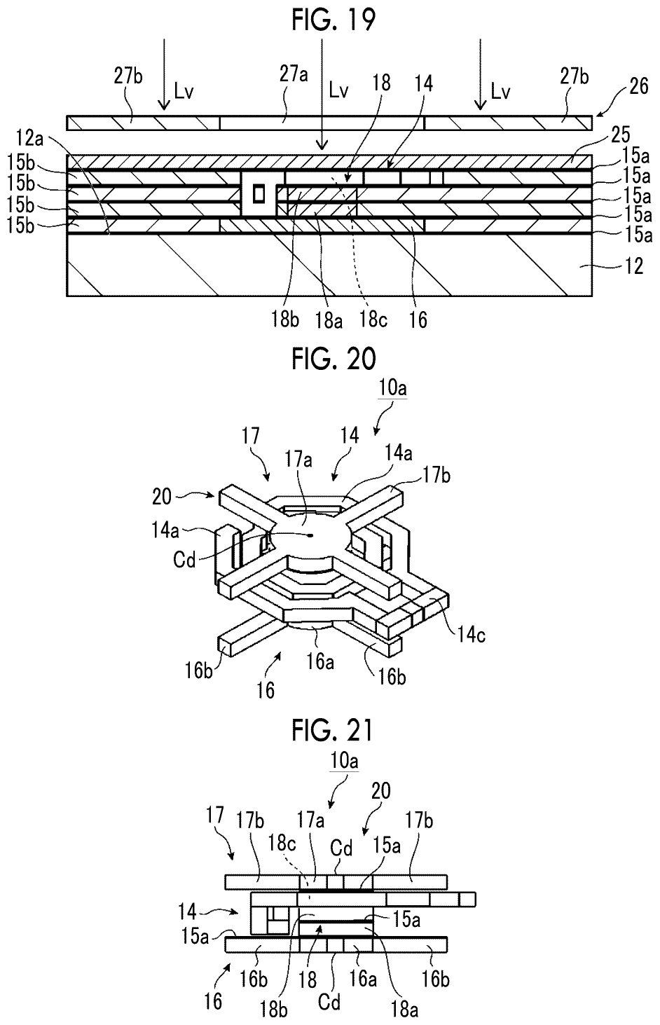

Next, as shown in FIG. 19, a photosensitive composition is applied onto the entire surface of the shield insulating layer 15a to form a composition layer 25. Then, a photo mask 26 is disposed on the composition layer 25 which is then subjected to exposure and a development treatment to form the second magnetic body portion 17 on the shield insulating layer 15a as shown in FIG. 1. The method for forming the composition layer 25 is the same as the method for forming the composition layer 21.

In addition, in the photo mask 26, for example, a mask portion 27b is provided in a region other than the region where the second magnetic body portion 17 is formed. A region 27a other than the mask portion 27b transmits the exposure light Lv that exposes the composition layer 25. The mask portion 27b blocks the exposure light Lv. The exposed portion of the composition layer 25 is the second magnetic body portion 17 (see FIG. 1).

The above-mentioned composition layer 21, composition layer 24, and composition layer 25 are formed of, for example, the same photosensitive composition.

After formation of the second magnetic body portion 17 (see FIG. 1) on the shield insulating layer 15a, the interlayer insulating layer 15b (see FIG. 1) is formed on the entire surface of the shield insulating layer 15a to cover the second magnetic body portion 17. This results in the formation of the structure 10 shown in FIG. 1. The method for forming the interlayer insulating layer 15b is as described above.

### [Second to Seventeenth Examples of Structure]

FIG. 20 is a schematic perspective view showing a second example of the structure according to the embodiment of the present invention and FIG. 21 is a schematic side view showing the second example of the structure according to the embodiment of the present invention. In FIG. 20 and FIG. 21, the same components as those of the structure 10 shown in FIG. 1 and the planar inductor 14 shown in FIG. 2 are denoted by the same reference numerals, and the detailed description thereof will be omitted. In addition, in FIG. 20 and FIG. 21, the substrate 12, a part of the shield insulating layers 15a and the interlayer insulating layers 15b constituting the first insulating layer 15, and the second insulating layer 19 shown in FIG. 1 are not shown. FIG. 21 is a side view seen from the same direction as in FIG. 1.

A structure 10a shown in FIG. 20 and FIG. 21 is different from the structure 10 shown in FIG. 1 and the planar inductor 14 shown in FIG. 2 in the configuration of the first magnetic body portion 16, the second magnetic body portion 17, and the third magnetic body portion 18 (three magnetic bodies 18a, 18b, and 18c).

The structure 10a has a configuration in which the first magnetic body portion 16 consists of a first center portion 16a and a plurality of extending portions 16b that extend outward from the first center portion 16a in an in-plane direction. The first center portion 16a has a circular outer shape. The number of extending portions 16b is 4, and the extending portions 16b are disposed at intervals of 90° with respect to a center Cd of the first center portion 16a. That is, the four extending portions 16b are disposed at equal intervals with respect to the center Cd of the first center portion 16a. One of the four extending portions 16b is disposed between the two strip-shaped members 14a connected to the power supply port 14c of the planar inductor 14.

The second magnetic body portion 17 has a similar configuration to the first magnetic body portion 16. The second magnetic body portion 17 has a configuration which consists of a second center portion 17a and a plurality of extending portions 17b that extend outward from the second center portion 17a in an in-plane direction. The second center portion 17a has a circular outer shape. The number of extending portions 17b is 4, and the extending portions 17b are disposed at intervals of 90° with respect to a center Cd of the second center portion 17a. That is, the four extending portions 17b are disposed at equal intervals with respect to the center Cd of the second center portion 17a. One of the four extending portions 17b is disposed between the two strip-shaped members 14a connected to the power supply port 14c of the planar inductor 14.

The first magnetic body portion 16 and the second magnetic body portion 17 have the same shape, and in a normal direction of the substrate 12 (see FIG. 1) of the structure 10a, that is, in a case of being viewed from a direction perpendicular to the center Cd of the second center portion 17a, the outer shape of the first magnetic body portion 16 and the outer shape of the second magnetic body portion 17 are disposed to overlap with each other. This is preferable because a large number of magnetic lines generated at the opening portion 14b of the planar inductor 14 pass through the first magnetic body portion 16 and the second magnetic body portion 17, so leakage magnetism is further suppressed.

The third magnetic body portion 18 is not of a single member, but is divided into a plurality of portions, is composed of a plurality of magnetic bodies, and is divided into, for example, three magnetic bodies 18a, 18b, and 18c. The three magnetic bodies 18a, 18b, and 18c are electrically insulated from one another by the shield insulating layer 15a. The number of divisions of the third magnetic body portion 18 is not particularly limited.

The structure 10a can obtain the same effects as the structure 10 and further allows the volume of the magnetic body portion 20 to be reduced, thereby making it possible to reduce the amount of the magnetic body used.

The structure 10a shown in FIG. 20 and FIG. 21 may have a configuration in which the extending portions 16b of the first magnetic body portion 16 and the extending portions 17b of the second magnetic body portion 17 are not disposed between the two strip-shaped members 14a connected to the power supply port 14c of the planar inductor 14 by changing the disposition of the extending portions 16b of the first magnetic body portion 16 and the extending portions 17b of the second magnetic body portion 17.

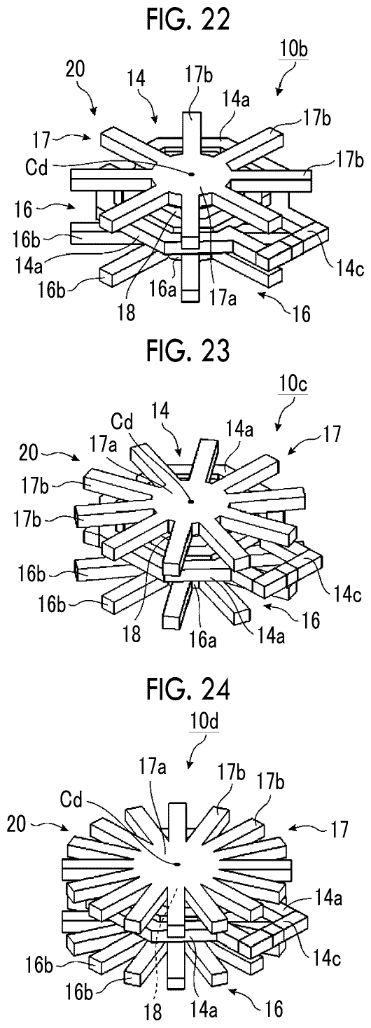

FIG. 22 is a schematic perspective view showing a third example of the structure according to the embodiment of the present invention. In FIG. 22, the same components as those of the structure 10a shown in FIG. 20 and FIG. 21 are denoted by the same reference numerals, and the detailed description thereof will be omitted. In FIG. 22 to FIG. 35 shown below, the disposition of the planar inductor 14, the first magnetic body portion 16, the second magnetic body portion 17, and the third magnetic body portion 18 is shown, and the substrate 12, the shield insulating layer 15a and the interlayer insulating layer 15b constituting the first insulating layer 15, and the second insulating layer 19 shown in FIG. 1 are not shown.

A structure 10b shown in FIG. 22 has the same configuration as the structure 10a shown in FIG. 20 and FIG. 21, except that the number of extending portions 16b of the first magnetic body portion 16 and the number of extending portions 17b of the second magnetic body portion 17 are different from those of the structure 10a shown in FIG. 20 and FIG. 21.

In the structure 10b shown in FIG. 22, the number of extending portions 16b of the first magnetic body portion 16 is 8, and the number of extending portions 17b of the second magnetic body portion 17 is 8.

In the structure 10b, the first magnetic body portion 16 and the second magnetic body portion 17 have the same shape, and in a case where the structure 10a is viewed from a direction perpendicular to the center Cd of the second center portion 17a, the outer shape of the first magnetic body portion 16 and the outer shape of the second magnetic body portion 17 are disposed to overlap with each other. This is preferable because a large number of magnetic lines generated at the opening portion 14b of the planar inductor 14 pass through the first magnetic body portion 16 and the second magnetic body portion 17, so leakage magnetism is further suppressed.

FIG. 23 is a schematic perspective view showing a fourth example of the structure according to the embodiment of the present invention. In FIG. 23, the same components as those of the structure 10a shown in FIG. 20 and FIG. 21 are denoted by the same reference numerals, and the detailed description thereof will be omitted.

A structure 10c shown in FIG. 23 has the same configuration as the structure 10a shown in FIG. 20 and FIG. 21, except that the number of extending portions 16b of the first magnetic body portion 16 and the number of extending portions 17b of the second magnetic body portion 17 are different from those of the structure 10a shown in FIG. 20 and FIG. 21, and the extending portions 16b of the first magnetic body portion 16 and the extending portions 17b of the second magnetic body portion 17 are not disposed between the two strip-shaped members 14a connected to the power supply port 14c of the planar inductor 14.

In the structure 10c shown in FIG. 23, the number of extending portions 16b of the first magnetic body portion 16 is 10, and the number of extending portions 17b of the second magnetic body portion 17 is 10.

In the structure 10c, the first magnetic body portion 16 and the second magnetic body portion 17 have the same shape, and in a case where the structure 10a is viewed from a direction perpendicular to the center Cd of the second center portion 17a, the outer shape of the first magnetic body portion 16 and the outer shape of the second magnetic body portion 17 are disposed to overlap with each other. This is preferable because a large number of magnetic lines generated at the opening portion 14b of the planar inductor 14 pass through the first magnetic body portion 16 and the second magnetic body portion 17, so leakage magnetism is further suppressed.

FIG. 24 is a schematic perspective view showing a fifth example of the structure according to the embodiment of the present invention. In FIG. 24, the same components as those of the structure 10a shown in FIG. 20 and FIG. 21 are denoted by the same reference numerals, and the detailed description thereof will be omitted.

A structure 10d shown in FIG. 24 has the same configuration as the structure 10a shown in FIG. 20 and FIG. 21, except that the number of extending portions 16b of the first magnetic body portion 16 and the number of extending portions 17b of the second magnetic body portion 17 are different from those of the structure 10a shown in FIG. 20 and FIG. 21.

In the structure 10d shown in FIG. 24, the number of extending portions 16b of the first magnetic body portion 16 is 16, and the number of extending portions 17b of the second magnetic body portion 17 is 16.

In the structure 10d, the first magnetic body portion 16 and the second magnetic body portion 17 have the same shape, and in a case where the structure 10a is viewed from a direction perpendicular to the center Cd of the second center portion 17a, the outer shape of the first magnetic body portion 16 and the outer shape of the second magnetic body portion 17 are disposed to overlap with each other. This is preferable because a large number of magnetic lines generated at the opening portion 14b of the planar inductor 14 pass through the first magnetic body portion 16 and the second magnetic body portion 17, so leakage magnetism is further suppressed.

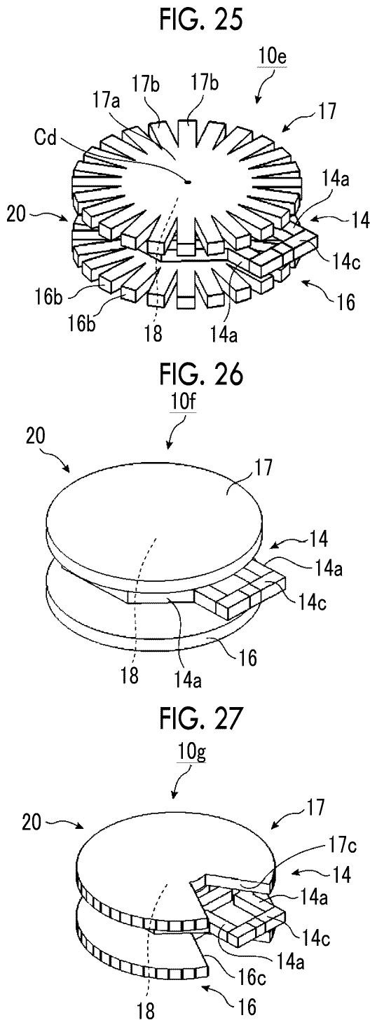

FIG. 25 is a schematic perspective view showing a sixth example of the structure according to the embodiment of the present invention. In FIG. 25, the same components as those of the structure 10a shown in FIG. 20 and FIG. 21 are denoted by the same reference numerals, and the detailed description thereof will be omitted.

A structure 10e shown in FIG. 25 has the same configuration as the structure 10a shown in FIG. 20 and FIG. 21, except that the number of extending portions 16b of the first magnetic body portion 16 and the number of extending portions 17b of the second magnetic body portion 17 are different from those of the structure 10a shown in FIG. 20 and FIG. 21.

In the structure 10e shown in FIG. 25, the number of extending portions 16b of the first magnetic body portion 16 is 24, and the number of extending portions 17b of the second magnetic body portion 17 is 24.

In the structure 10e, the first magnetic body portion 16 and the second magnetic body portion 17 have the same shape, and in a case where the structure 10a is viewed from a direction perpendicular to the center Cd of the second center portion 17a, the outer shape of the first magnetic body portion 16 and the outer shape of the second magnetic body portion 17 are disposed to overlap with each other. This is preferable because a large number of magnetic lines generated at the opening portion 14b of the planar inductor 14 pass through the first magnetic body portion 16 and the second magnetic body portion 17, so leakage magnetism is further suppressed.

With regard to the above-mentioned structure 10a to structure 10e, it is further preferable that the first magnetic body portion 16 and the second magnetic body portion 17 are disposed to overlap with each other in alignment with the outer shape of the second magnetic body portion 17 such that the outer shape of the first magnetic body portion 16 is not visible in the normal direction of the substrate 12 (see FIG. 1) of the structure 10a, that is, in a case of being viewed from a direction perpendicular to the center Cd of the second center portion 17a. As a result, leakage magnetism is further suppressed.

FIG. 26 is a schematic perspective view showing a seventh example of the structure according to the embodiment of the present invention. In FIG. 26, the same components as those of the structure 10a shown in FIG. 20 and FIG. 21 are denoted by the same reference numerals, and the detailed description thereof will be omitted.

A structure 10f shown in FIG. 26 has the same configuration as the structure 10a shown in FIG. 20 and FIG. 21, except that the first magnetic body portion 16 is composed of a disk and the second magnetic body portion 17 is composed of a disk, as compared with the structure 10a shown in FIG. 20 and FIG. 21.

FIG. 27 is a schematic perspective view showing an eighth example of the structure according to the embodiment of the present invention. In FIG. 27, the same components as those of the structure 10a shown in FIG. 20 and FIG. 21 are denoted by the same reference numerals, and the detailed description thereof will be omitted.

A structure 10g shown in FIG. 27 has the same configuration as the structure 10a shown in FIG. 20 and FIG. 21, except that the number of extending portions 16b of the first magnetic body portion 16 and the number of extending portions 17b of the second magnetic body portion 17 are different from those of the structure 10a shown in FIG. 20 and FIG. 21, and the first magnetic body portion 16 and the second magnetic body portion 17 have notched portions 16c and 17c formed at positions corresponding to the power supply port 14c of the planar inductor 14. The notched portions 16c and 17c are formed by partially removing the first magnetic body portion 16 and the second magnetic body portion 17.

In the structure 10g shown in FIG. 27, the number of extending portions 16b of the first magnetic body portion 16 is 48, and the number of extending portions 17b of the second magnetic body portion 17 is 48.

In addition, the first magnetic body portion 16 has the notched portion 16c formed at a position corresponding to the power supply port 14c of the planar inductor 14.

In addition, the second magnetic body portion 17 has the notched portion 17c formed at a position corresponding to the power supply port 14c of the planar inductor 14.

In the structure 10g shown in FIG. 27, the number of extending portions 16b of the first magnetic body portion 16 may be either 16 or 24, and the number of extending portions 17b of the second magnetic body portion 17 may be either 16 or 24.

In addition, in the structure 10f shown in FIG. 26 described above, similar to the structure 10g shown in FIG. 27, the first magnetic body portion 16 and the second magnetic body portion 17 can be configured to have the notched portions 16c and 17c formed at positions corresponding to the power supply port 14c of the planar inductor 14.

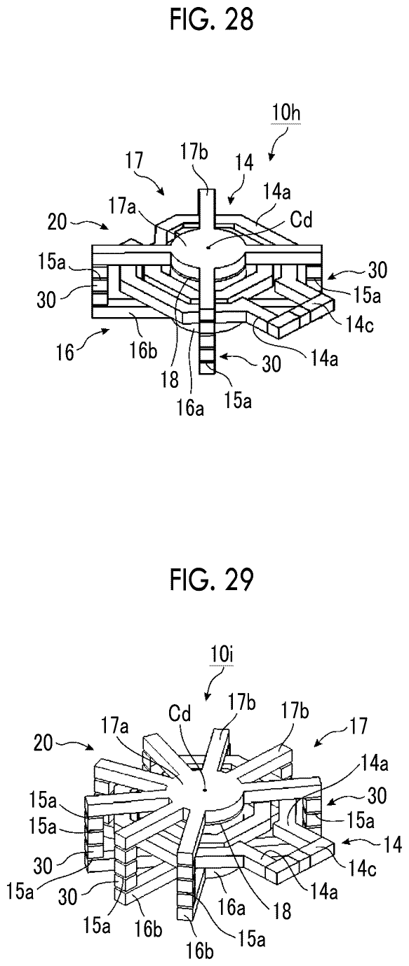

FIG. 28 is a schematic perspective view showing a ninth example of the structure according to the embodiment of the present invention. In FIG. 28, the same components as those of the structure 10a shown in FIG. 20 and FIG. 21 are denoted by the same reference numerals, and the detailed description thereof will be omitted.

A structure 10h shown in FIG. 28 has the same configuration as the structure 10a shown in FIG. 20 and FIG. 21, except that a connecting portion 30 is provided between the extending portion 16b of the first magnetic body portion 16 and the extending portion 17b of the second magnetic body portion 17, and the extending portion 16b of the first magnetic body portion 16 and the extending portion 17b of the second magnetic body portion 17 are not disposed between the two strip-shaped members 14a connected to the power supply port 14c of the planar inductor 14, as compared with the structure 10a shown in FIG. 20 and FIG. 21.

The connecting portion 30 has a similar configuration to the first magnetic body portion 16, the second magnetic body portion 17, and the third magnetic body portion 18 (three magnetic bodies 18a, 18b, and 18c).

Similar to the third magnetic body portion 18, the connecting portion 30 is divided into three portions, each of which is electrically insulated by the shield insulating layer 15a. In addition, the connection portion 30 is also electrically insulated from the first magnetic body portion 16 and the second magnetic body portion 17 by the shield insulating layer 15a. In a case where the number of divisions of the connecting portion 30 is the same as the number of divisions of the third magnetic body portion 18, each member of the connecting portion 30 can be formed in a case where the three magnetic bodies 18a, 18b, and 18c of the third magnetic body portion 18 are formed.

FIG. 29 is a schematic perspective view showing a tenth example of the structure according to the embodiment of the present invention. In FIG. 29, the same components as those of the structure 10h shown in FIG. 28 are denoted by the same reference numerals, and the detailed description thereof will be omitted.

A structure 10i shown in FIG. 29 has the same configuration as the structure 10h shown in FIG. 28, except that the number of extending portions 16b of the first magnetic body portion 16 and the number of extending portions 17b of the second magnetic body portion 17 are different from those of the structure 10h shown in FIG. 28.

In the structure 10i shown in FIG. 29, the number of extending portions 16b of the first magnetic body portion 16 is 8, and the number of extending portions 17b of the second magnetic body portion 17 is 8.

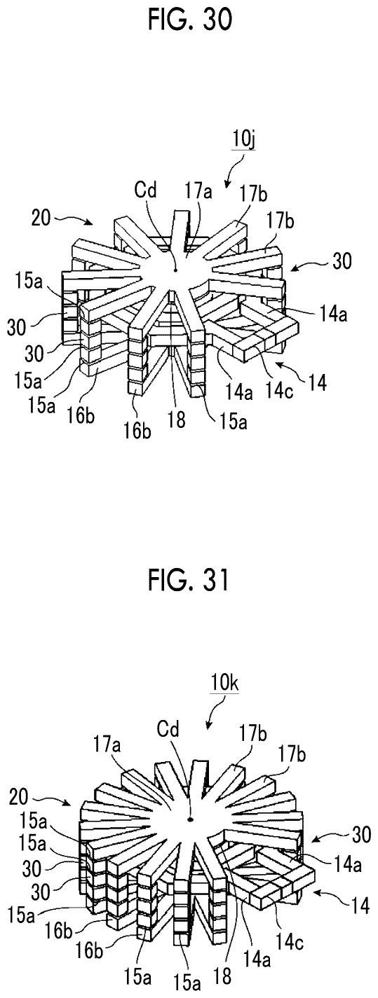

FIG. 30 is a schematic perspective view showing an eleventh example of the structure according to the embodiment of the present invention. In FIG. 30, the same components as those of the structure 10h shown in FIG. 28 are denoted by the same reference numerals, and the detailed description thereof will be omitted.

A structure 10j shown in FIG. 30 has the same configuration as the structure 10h shown in FIG. 28, except that the number of extending portions 16b of the first magnetic body portion 16 and the number of extending portions 17b of the second magnetic body portion 17 are different from those of the structure 10h shown in FIG. 28.

In the structure 10j shown in FIG. 30, the number of extending portions 16b of the first magnetic body portion 16 is 10, and the number of extending portions 17b of the second magnetic body portion 17 is 10.

FIG. 31 is a schematic perspective view showing a twelfth example of the structure according to the embodiment of the present invention. In FIG. 31, the same components as those of the structure 10h shown in FIG. 28 are denoted by the same reference numerals, and the detailed description thereof will be omitted.

A structure 10k shown in FIG. 31 has the same configuration as the structure 10h shown in FIG. 28, except that the number of extending portions 16b of the first magnetic body portion 16 and the number of extending portions 17b of the second magnetic body portion 17 are different from those of the structure 10h shown in FIG. 28.

In the structure 10k shown in FIG. 31, the number of extending portions 16b of the first magnetic body portion 16 is 16, and the number of extending portions 17b of the second magnetic body portion 17 is 16.

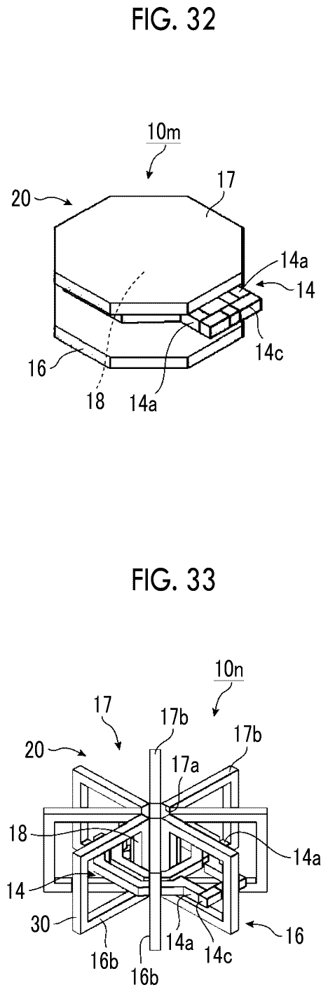

FIG. 32 is a schematic perspective view showing a thirteenth example of the structure according to the embodiment of the present invention. In FIG. 32, the same components as those of the structure 10a shown in FIG. 20 and FIG. 21 are denoted by the same reference numerals, and the detailed description thereof will be omitted.

A structure 10m shown in FIG. 32 has the same configuration as the structure 10a shown in FIG. 20 and FIG. 21, except that the first magnetic body portion 16 is composed of an octagonal plate and the second magnetic body portion 17 is composed of an octagonal plate, as compared with the structure 10a shown in FIG. 20 and FIG. 21.

In addition, in the structure 10m shown in FIG. 32 described above, similar to the structure 10g shown in FIG. 27, the first magnetic body portion 16 and the second magnetic body portion 17 can be configured to have the notched portions 16c and 17c formed at positions corresponding to the power supply port 14c of the planar inductor 14.

The first magnetic body portion 16 and the second magnetic body portion 17 have an octagonal outer shape, but the outer shape of the first magnetic body portion 16 and the second magnetic body portion 17 is not limited to an octagonal shape and may be a polygonal shape other than an octagonal shape. In this regard, it is preferable that the first magnetic body portion 16 and the second magnetic body portion 17 have a shape that is a continuous body in a radiation direction from the viewpoint of the Q value and the like. The radiation direction is a direction extending in all directions from a single point.

FIG. 33 is a schematic perspective view showing a fourteenth example of the structure according to the embodiment of the present invention. In FIG. 33, the same components as those of the structure 10a shown in FIG. 20 and FIG. 21 are denoted by the same reference numerals, and the detailed description thereof will be omitted.

A structure 10n shown in FIG. 33 has the same configuration as the structure 10a shown in FIG. 20 and FIG. 21, except that the number of extending portions 16b of the first magnetic body portion 16 and the number of extending portions 17b of the second magnetic body portion 17 are different from those of the structure 10a shown in FIG. 20 and FIG. 21, the extending portion 16b of the first magnetic body portion 16 and the extending portion 17b of the second magnetic body portion 17 are connected to each other by the connecting portion 30, and the third magnetic body portion 18 (three magnetic bodies 18a, 18b, and 18c) has a tubular shape.

In the structure 10n shown in FIG. 33, the number of extending portions 16b of the first magnetic body portion 16 is 8, and the number of extending portions 17b of the second magnetic body portion 17 is 8.

In the structure 10n shown in FIG. 33, the planar inductor 14 is surrounded by the connecting portion 30.

The connecting portion 30 has a similar configuration to the first magnetic body portion 16, the second magnetic body portion 17, and the third magnetic body portion 18 (three magnetic bodies 18a, 18b, and 18c).

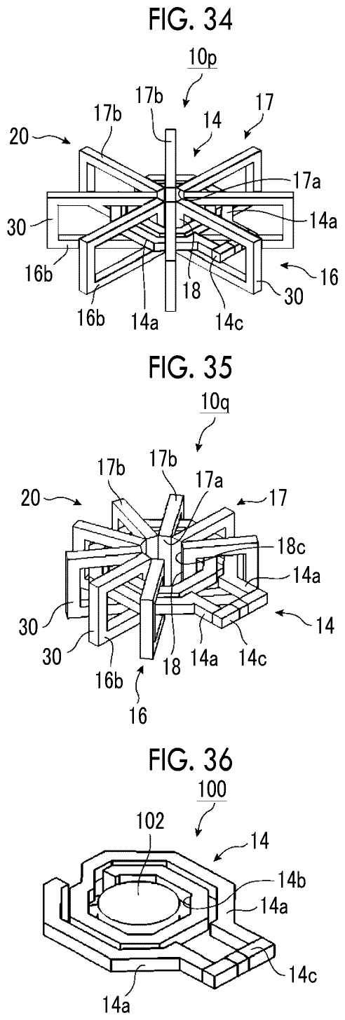

FIG. 34 is a schematic perspective view showing a fifteenth example of the structure according to the embodiment of the present invention. In FIG. 34, the same components as those of the structure 10n shown in FIG. 33 are denoted by the same reference numerals, and the detailed description thereof will be omitted.

A structure 10p shown in FIG. 34 has the same configuration as the structure 10n shown in FIG. 33, except that the third magnetic body portion 18 (three magnetic bodies 18a, 18b, and 18c) is shorter than the third magnetic body portion 18 of the structure 10n shown in FIG. 33.

FIG. 35 is a schematic perspective view showing a sixteenth example of the structure according to the embodiment of the present invention. In FIG. 35, the same components as those of the structure 10n shown in FIG. 33 are denoted by the same reference numerals, and the detailed description thereof will be omitted.

A structure 10q shown in FIG. 35 has the same configuration as the structure 10n shown in FIG. 33, except that the third magnetic body portion 18 (three magnetic bodies 18a, 18b, and 18c) is shorter than the third magnetic body portion 18 of the structure 10n shown in FIG. 33, and the extending portion 16b of the first magnetic body portion 16 and the extending portion 17b of the second magnetic body portion 17 are not disposed between the two strip-shaped members 14a connected to the power supply port 14c of the planar inductor 14.

### <Other Configurations>

A variety of antennas used in the communication standard fifth generation (5G) using a frequency band of 28 GHz to 80 GHz can be used as the antenna.

For example, a patch antenna, a dipole antenna, and a phased array antenna can be used as the antenna.

The antenna is composed of, for example, copper or aluminum. In addition, the thickness of the antenna is preferably 20 to 50 μm. For example, in a case where a printed substrate such as Flame Retardant Type 1 to Type 5 (FR-1 to FR-5) is used, a thickness of a copper wiring line is determined by the standards, and the thickness of the antenna also conforms to the thickness of the copper wiring line. In addition, the thickness of the antenna may conform to a thickness of copper foil (see Table 6 and the like of the Japanese Industrial Standards (JIS) C 6484: 2005) of a copper-clad laminate specified in JIS C 6484: 2005. Further, in a case where the antenna is formed of copper by electrolytic plating, the thickness of the antenna is preferably a film thickness that can be formed by electrolytic plating.

Examples of the semiconductor element include the following.

The semiconductor element is not particularly limited, and examples thereof include logic large scale integration (LSI) (for example, an application specific integrated circuit (ASIC), a field programmable gate array (FPGA), and an application specific standard product (ASSP)), microprocessors (for example, a central processing unit (CPU) and a graphics processing unit (GPU)), memories (for example, a dynamic random access memory (DRAM), a hybrid memory cube (HMC), a magnetic RAM (MRAM), a phase-change memory (PCM), a resistive RAM (ReRAM), a ferroelectric RAM (FeRAM), and a flash memory (such as a Not AND (NAND) flash)), power devices, analog integrated circuits (IC) (for example, a direct current (DC)-direct current (DC) converter and an isolated gate bipolar transistor (IGBT)), A/D converters, micro electro mechanical systems (MEMS) (for example, an acceleration sensor, a pressure sensor, an oscillator, and a gyro sensor), power amplifiers, wireless (for example, a global positioning system (GPS), frequency modulation (FM), near field communication (NFC), an RF expansion module (RFEM), a monolithic microwave integrated circuit (MMIC), and a wireless local area network (WLAN)), discrete elements, back side illumination (BSI), contact image sensors (CIS), camera modules, CMOS, passive devices, bandpass filters, surface acoustic wave (SAW) filters, radio frequency (RF) filters, radio frequency integrated passive devices (RFIPD), and broadband (BB).

Hereinafter, the photosensitive composition and the method for manufacturing the structure will be described.

The photosensitive composition may be a negative type photosensitive composition or a positive type photosensitive composition. In a case of a negative type photosensitive composition, the composition often contains a polymerizable compound which will be described later.

The photosensitive composition is a composition used for the formation of the first magnetic body portion, the second magnetic body portion, and the third magnetic body portion.

It is preferable that the magnetic permeability of each of the first magnetic body portion, the second magnetic body portion, and the third magnetic body portion formed of the composition is 1 to 10000 at a frequency of 10 MHz to 500 MHz, 1 to 1000 at a frequency of more than 500 MHz and 10 GHz or less, and 1 to 100 at a frequency of more than 10 GHz and 100 GHz or less.

In the following, first, various components contained in the photosensitive composition will be described in detail.

### [Magnetic Particles]

The photosensitive composition contains magnetic particles. The magnetic particle may be one type or a plurality of types.

The magnetic particles contain a metal atom.

In the present specification, the metal atom also includes metalloid atoms such as boron, silicon, germanium, arsenic, antimony, and tellurium.

The metal atom may be contained in the magnetic particles as an alloy containing a metal element (preferably a magnetic alloy), a metal oxide (preferably a magnetic oxide), a metal nitride (preferably a magnetic nitride), or a metal carbide (preferably a magnetic carbide).

The content of the metal atom with respect to the total mass of the magnetic particles is preferably 50% to 100% by mass, more preferably 75% to 100% by mass, and still more preferably 95% to 100% by mass.

The metal atom is not particularly limited and preferably includes at least one metal element of Ni, Co, or Fe.

The content of at least one metal element of Ni, Co, or Fe (the total content of a plurality of types of metal elements in a case where the plurality of types of metal elements are contained) is preferably 50% by mass or more, more preferably 60% by mass or more, and still more preferably 70% by mass or more with respect to the total mass of the metal atoms in the magnetic particles. The upper limit value of the content of the metal element is not particularly limited, and is, for example, 100% by mass or less, preferably 98% by mass or less, and more preferably 95% by mass or less.

The magnetic particles may contain a material other than Ni, Co, and Fe, specific examples of which include Al, Si, S, Sc, Ti, V, Cu, Y, Mo, Rh, Pd, Ag, Sn, Sb, Te, Ba, Ta, W, Re, Au, Bi, La, Ce, Pr, Nd, P, Zn, Zr, Mn, Cr, Nb, Pb, Ca, B, C, N, and O.

In a case where the magnetic particles contain a metal atom other than Ni, Co, and Fe, it is preferable that the magnetic particles contain one or more selected from the group consisting of Si, Cr, B, and Mo.

Examples of the magnetic particles include alloys such as a Fe—Co-based alloy (preferably Permendur), a Fe—Ni-based alloy (for example, Permalloy), a Fe—Zr-based alloy, a Fe—Mn-based alloy, a Fe—Si-based alloy, a Fe—Al-based alloy, a Ni—Mo-based alloy (preferably Supermalloy), a Fe—Ni—Co-based alloy, a Fe—Si—Cr-based alloy, a Fe—Si—B-based alloy, a Fe—Si—Al-based alloy (preferably Sendust), a Fe—Si—B—C-based alloy, a Fe—Si—B—Cr-based alloy, a Fe—Si—B—Cr—C-based alloy, a Fe—Co—Si—B-based alloy, a Fe—Si—B—Nb-based alloy, a Fe nanocrystalline alloy, a Fe-based amorphous alloy, and a Co-based amorphous alloy, as well as ferrites such as a spinel ferrite (preferably a Ni—Zn-based ferrite or a Mn—Zn-based ferrite) and a hexagonal ferrite (preferably a barium ferrite or a magnetoplumbite type hexagonal ferrite). The alloy may be amorphous.

The hexagonal ferrite which is preferable from the viewpoint of radio wave absorption performance may be, for example, a substituted magnetoplumbite type hexagonal ferrite in which some of iron atoms in hexagonal ferrite are substituted with aluminum atoms. Further, a Ba—Fe—Al-based alloy, a Ca—Fe—Al-based alloy, or a Pb—Fe—Al-based alloy in which a part of the alloy is substituted with Ba, Ca, or Pb is more preferable from the viewpoint of absorption of radio waves in a high frequency band.

The magnetic particles may be used alone or in combination of two or more thereof.

The magnetic particles may have a surface layer provided on the surface thereof. In a case where the magnetic particles have a surface layer in this manner, the magnetic particles can be endowed with a function according to the material of the surface layer. The surface layer may be, for example, an inorganic layer or an organic layer.

The thickness of the surface layer is not particularly limited and is preferably 3 to 1000 nm from the viewpoint that the function of the surface layer is more exhibited.

The average primary particle diameter of the magnetic particles is preferably 20 to 1000 nm. The number average particle diameter of the magnetic particles is more preferably 20 to 500 nm from the viewpoint of dispersion in a composition and pattern resolution.

The average primary particle diameter of the magnetic particles is measured in such a manner that the magnetic particles are imaged with a transmission electron microscope at an imaging magnification of 100,000 times, the magnetic particle image is printed on a printing paper at a total magnification of 500,000 times, and in the obtained particle image, the contour of the particles (primary particles) is traced with a digitizer and then the diameter of a circle having the same area as the traced region (equivalent circular area diameter) is calculated. Here, the primary particles refer to independent particles that are not aggregated. The imaging using a transmission electron microscope is carried out by a direct method using a transmission electron microscope at an acceleration voltage of 300 kV. The observation and measurement using a transmission electron microscope can be carried out using, for example, a transmission electron microscope (Model: H-9000, manufactured by Hitachi Ltd.) and image analysis software (KS-400, manufactured by Carl Zeiss AG). The particle diameters of the primary particles of at least 100 magnetic particles measured above are arithmetically averaged to calculate the average primary particle diameter.

The shape of the magnetic particle is not particularly limited, and may be any of a plate shape, an elliptical shape, a spherical shape, and an amorphous shape.

The content of the magnetic particles is preferably 20% to 99% by mass, more preferably 25% to 80% by mass, and still more preferably 30% to 60% by mass with respect to the total mass of the composition.

The content of the magnetic particles is preferably 30% to 99% by mass, more preferably 30% to 80% by mass, and still more preferably 40% to 70% by mass with respect to the total solid content of the composition.

The total solid content of the composition means the components constituting the magnetic pattern portion excluding the solvent in the composition. Any components constituting the magnetic pattern portion are considered to be the solid content even in a case where such components are in a liquid state.

### [Polymerizable Compound]

The photosensitive composition may contain a polymerizable compound.

The polymerizable compound is a compound having a polymerizable group (photopolymerizable compound), examples of which include a compound containing a group containing an ethylenically unsaturated bond (hereinafter, also simply referred to as an “ethylenically unsaturated group”) and a compound having an epoxy group and/or an oxetanyl group, with a compound containing an ethylenically unsaturated group being preferred.

The composition preferably contains a low-molecular-weight compound containing an ethylenically unsaturated group as the polymerizable compound.

The polymerizable compound is preferably a compound containing one or more ethylenically unsaturated bonds, more preferably a compound containing two or more ethylenically unsaturated bonds, still more preferably a compound containing three or more ethylenically unsaturated bonds, and particularly preferably a compound containing five or more ethylenically unsaturated bonds. The upper limit of the number of ethylenically unsaturated bonds is, for example, 15 or less. Examples of the ethylenically unsaturated group include a vinyl group, a (meth)allyl group, and a (meth)acryloyl group.

The polymerizable compound may have an acid group such as a carboxylic acid group, a sulfonic acid group, or a phosphoric acid group.

The acid value of the polymerizable compound containing an acid group is preferably 0.1 to 40 mgKOH/g and more preferably 5 to 30 mgKOH/g.

The content of the polymerizable compound in the composition is not particularly limited, and is preferably 1% to 40% by mass, more preferably 5% to 30% by mass, and still more preferably 10% to 25% by mass with respect to the total solid content of the composition.

The composition may contain materials other than the above-mentioned magnetic particles and polymerizable compound.

### [Resin]

The composition may contain a resin.

Examples of the resin include a (meth)acrylic resin, an epoxy resin, an ene-thiol resin, a polycarbonate resin, a polyether resin, a polyarylate resin, a polysulfone resin, a polyethersulfone resin, a polyphenylene resin, a polyarylene ether phosphine oxide resin, a polyimide resin, a polyamide imide resin, a polyolefin resin, a cyclic olefin resin, a polyester resin, a styrene resin, and a phenoxy resin.

One type of these resins may be used alone, or two or more types of these resins may be used in admixture.

A suitable aspect of the resin may be, for example, a resin having an unsaturated double bond (for example, an ethylenically unsaturated double bond) and a polymerizable group such as an epoxy group or an oxetanyl group.

In addition, a suitable aspect of the resin may be, for example, a resin having an acid group, a basic group, or an amide group. The resin having an acid group, a basic group, or an amide group tends to exhibit a function as a dispersant for dispersing magnetic particles.

Examples of the acid group include a carboxy group, a phosphoric acid group, a sulfo group, and a phenolic hydroxyl group, among which a carboxy group is preferable.

Examples of the basic group include an amino group (a group obtained by removing one hydrogen atom from ammonia, a primary amine, or a secondary amine) and an imino group.

Above all, the resin preferably has a carboxy group or an amide group.

The content of the resin is preferably 0.1% to 30% by mass, more preferably 1% to 25% by mass, and still more preferably 5% to 20% by mass with respect to the total mass of the composition.

A suitable aspect of the resin may be, for example, a resin that functions as a dispersant for dispersing magnetic particles in the composition (hereinafter, also referred to as a “dispersion resin”). The effect of the present invention is more excellent by using the dispersion resin.

### [Resin Having Repeating Unit Containing Graft Chain]

The dispersion resin may be, for example, a resin having a repeating unit containing a graft chain (hereinafter, also referred to as “resin A”). In this regard, the resin A can be used for purposes other than functioning as a dispersant.

In a case where the composition contains the resin A, the content of the resin A is preferably 0.1% to 30% by mass, more preferably 0.5% to 20% by mass, and still more preferably 1% to 10% by mass with respect to the total mass of the composition, from the viewpoint that the effect of the present invention is more excellent.

### Repeating Unit Containing Graft Chain

In the repeating unit containing a graft chain, a longer graft chain leads to a higher steric repulsion effect, which improves the dispersibility of magnetic particles. On the other hand, in a case where the graft chain is too long, the adsorption power to the magnetic particles tends to decrease, and therefore the dispersibility of the magnetic particles tends to decrease. For this reason, the graft chain preferably has 40 to 10000 atoms excluding hydrogen atoms, more preferably 50 to 2000 atoms excluding hydrogen atoms, and still more preferably 60 to 500 atoms excluding hydrogen atoms.

Here, the graft chain refers to a portion extending from a root of a main chain (an atom in a group branching off from the main chain which is bonded to the main chain) to a terminal of the group branching off from the main chain.

In addition, the graft chain preferably contains a polymer structure, and examples of such a polymer structure include a poly(meth)acrylate structure (for example, a poly(meth)acrylic structure), a polyester structure, a polyurethane structure, a polyurea structure, a polyamide structure, and a polyether structure.

In order to improve the interactive properties between the graft chain and the solvent and thereby enhance the dispersibility of the magnetic particles, the graft chain is preferably a graft chain containing at least one selected from the group consisting of a polyester structure, a polyether structure, and a poly(meth)acrylate structure, and more preferably a graft chain containing at least one of a polyester structure or a polyether structure.

In the resin A, the content of the repeating unit containing a graft chain in terms of mass is preferably 2% to 100% by mass, more preferably 2% to 90% by mass, and still more preferably 5% to 30% by mass with respect to the total mass of the resin A. The effect of the present invention is more excellent in a case where the content of the repeating unit containing a graft chain is within this range.

### Hydrophobic Repeating Unit

In addition, the resin A may contain a hydrophobic repeating unit that is different from the repeating unit containing a graft chain (that is, a hydrophobic repeating unit that does not correspond to the repeating unit containing a graft chain). In this regard, in the present specification, the hydrophobic repeating unit is a repeating unit that does not have an acid group (for example, a carboxylic acid group, a sulfonic acid group, a phosphoric acid group, or a phenolic hydroxyl group).

The hydrophobic repeating unit is preferably a repeating unit derived from (corresponding to) a compound (monomer) having a C log P value of 1.2 or more, and more preferably a repeating unit derived from a compound having a C log P value of 1.2 to 8. This makes it possible to more reliably exhibit the effect of the present invention.

The C log P value is a value calculated by a program “C LOG P” which is available from Daylight Chemical Information System, Inc. This program provides a value of a “calculated log P” calculated by the fragment approach of Hansch and Leo (see the literature below). The fragment approach is based on a chemical structure of a compound, and is carried out in such a manner that the chemical structure is divided into partial structures (fragments), and the log P contributions assigned to the fragments are summed up to estimate the log P value of the compound. The details of the fragment approach are described in the following literature. In the present specification, C log P values calculated by a program C LOG P v4.82 are used.

A. J. Leo, Comprehensive Medicinal Chemistry, Vol. 4, C. Hansch, P. G. Sammnens, J. B. Taylor and C. A. Ramsden, Eds., p. 295, Pergamon Press, 1990 C. Hansch & A. J. Leo. Substituent Constants For Correlation Analysis in Chemistry and Biology. John Wiley & Sons. A. J. Leo. Calculating log Poct from structure. Chem. Rev., 93, 1281-1306, 1993.

The log P means a common logarithm of a partition coefficient P, and is a physical property value that expresses, in terms of a quantitative numerical value, how a certain organic compound is partitioned at an equilibrium in a two-phase system consisting of oil (generally 1-octanol) and water. The log P is expressed by the following expression.

log P=log(Coil/Cwater)

In the expression, Coil represents a molar concentration of a compound in an oil phase, and Cwater represents a molar concentration of a compound in a water phase.

In a case where a value of log P increases positively across 0, the oil solubility increases, and in a case where a value of log P increases negatively in terms of an absolute value, the water solubility increases. The value of log P is negatively correlated with the water solubility of an organic compound and is widely used as a parameter for estimating the hydrophilicity or hydrophobicity of an organic compound.

The content of the hydrophobic repeating unit in the resin A in terms of mass is preferably 10% to 90% by mass and more preferably 20% to 80% by mass with respect to the total mass of the resin A.

Functional Group Capable of Forming Interaction with Magnetic Particles

The resin A may have a functional group capable of forming an interaction with magnetic particles.

The resin A preferably further contains a repeating unit containing a functional group capable of forming an interaction with magnetic particles.

Examples of the functional group capable of forming an interaction with magnetic particles include an acid group, a basic group, a coordinating group, and a functional group having reactivity.

In a case where the resin A contains an acid group, a basic group, a coordinating group, or a functional group having reactivity, the resin A preferably contains a repeating unit containing an acid group, a repeating unit containing a basic group, a repeating unit containing a coordinating group, or a repeating unit having a functional group having reactivity, respectively.

Examples of the acid group, which is a functional group capable of forming an interaction with magnetic particles, include a carboxylic acid group, a sulfonic acid group, a phosphoric acid group, and a phenolic hydroxyl group, with at least one of a carboxylic acid group, a sulfonic acid group, or a phosphoric acid group being preferred, and a carboxylic acid group being more preferred. The carboxylic acid group has favorable adsorption power to magnetic particles and high dispersibility.

That is, it is preferable that the resin A further contains a repeating unit containing at least one of a carboxylic acid group, a sulfonic acid group, or a phosphoric acid group.

The resin A may have one or two or more repeating units containing an acid group.

In a case where the resin A contains a repeating unit containing an acid group, the content of the repeating unit containing an acid group in terms of mass is preferably 5% to 80% by mass and more preferably 10% to 60% by mass with respect to the total mass of the resin A.

Examples of the basic group, which is a functional group capable of forming an interaction with magnetic particles, include a primary amino group, a secondary amino group, a tertiary amino group, a heterocyclic ring containing an N atom, and an amide group. From the viewpoint of favorable adsorption power to magnetic particles and high dispersibility, the preferred basic group is a tertiary amino group. The resin A may contain one or two or more of these basic groups.

In a case where the resin A contains a repeating unit containing a basic group, the content of the repeating unit containing a basic group in terms of mass is preferably 0.01% to 50% by mass and more preferably 0.01% to 30% by mass with respect to the total mass of the resin A.

Examples of the coordinating group and the functional group having reactivity, which are functional groups capable of forming an interaction with magnetic particles, include an acetylacetoxy group, a trialkoxysilyl group, an isocyanate group, an acid anhydride, and an acid chloride. From the viewpoint of favorable adsorption power to magnetic particles and high dispersibility of magnetic particles, the preferred functional group is an acetylacetoxy group. The resin A may have one or two or more of these groups.

In a case where the resin A contains a repeating unit containing a coordinating group or a repeating unit containing a functional group having reactivity, the content of the repeating unit containing a coordinating group or the repeating unit containing a functional group having reactivity in terms of mass is preferably 10% to 80% by mass and more preferably 20% to 60% by mass with respect to the total mass of the resin A.

### Ethylenically Unsaturated Group

The resin A may contain an ethylenically unsaturated group.

The ethylenically unsaturated group is not particularly limited, and examples thereof include a (meth)acryloyl group, a vinyl group, and a styryl group, with a (meth)acryloyl group being preferred.

Above all, the resin A preferably contains a repeating unit containing an ethylenically unsaturated group in the side chain, and more preferably a repeating unit containing an ethylenically unsaturated group in the side chain and derived from (meth)acrylate.

In a case where the resin A contains a repeating unit containing an ethylenically unsaturated group, the content of the repeating unit containing an ethylenically unsaturated group in terms of mass is preferably 30% to 70% by mass and more preferably 40% to 60% by mass with respect to the total mass of the resin A.

### Other Repeating Units

Further, for the purpose of improving various performances such as a film forming ability, the resin A may further have other repeating units having various functions, which are different from the repeating unit containing a graft chain, the hydrophobic repeating unit, and the repeating unit containing a functional group capable of forming an interaction with magnetic particles, as long as the effect of the present invention is not impaired.

Examples of such other repeating units include repeating units derived from radically polymerizable compounds selected from acrylonitriles, methacrylonitriles, and the like.

One or two or more of these other repeating units can be used in the resin A, and the content thereof in terms of mass is preferably 0% to 80% by mass and more preferably 10% to 60% by mass with respect to the total mass of the resin A.

### Physical Properties of Resin A

The acid value of the resin A is not particularly limited and is, for example, preferably 0 to 400 mgKOH/g, more preferably 10 to 350 mgKOH/g, still more preferably 30 to 300 mgKOH/g, and particularly preferably 50 to 200 mgKOH/g.

In a case where the acid value of the resin A is 50 mgKOH/g or more, the sedimentation stability of the magnetic particles can be further improved.

In the present specification, the acid value can be calculated, for example, from an average content of acid groups in a compound. In addition, a resin having a desired acid value can be obtained by changing the content of the repeating unit containing an acid group in the resin.

The weight-average molecular weight of the resin A is not particularly limited and is, for example, preferably 3,000 or more, more preferably 4,000 or more, still more preferably 5,000 or more, and particularly preferably 6,000 or more. In addition, the upper limit value of the weight-average molecular weight of the resin A is, for example, preferably 300,000 or less, more preferably 200,000 or less, still more preferably 100,000 or less, and particularly preferably 50,000 or less.

The resin A can be synthesized based on a known method.

### <Alkali-Soluble Resin>

The resin may include an alkali-soluble resin. In the present specification, the alkali-soluble resin means a resin containing a group that promotes alkali solubility (an alkali-soluble group, for example, an acid group such as a carboxylic acid group), and means a resin different from the resin A described above.

The alkali-soluble resin may be, for example, a resin containing at least one alkali-soluble group in a molecule, examples of which include a polyhydroxystyrene resin, a polysiloxane resin, a (meth)acrylic resin, a (meth)acrylamide resin, a (meth)acryl/(meth)acrylamide copolymer, an epoxy resin, and a polyimide resin.

Specific examples of the alkali-soluble resin include a copolymer of an unsaturated carboxylic acid and an ethylenically unsaturated compound.

The unsaturated carboxylic acid is not particularly limited, and examples thereof include monocarboxylic acids such as (meth)acrylic acid, crotonic acid, and vinylacetic acid; dicarboxylic acids such as itaconic acid, maleic acid, and fumaric acid, or acid anhydrides thereof, and polyvalent carboxylic acid monoesters such as mono-(2-(meth)acryloyloxyethyl) phthalate.

An alkali-soluble resin containing a curable group is also preferable as the alkali-soluble resin.

Examples of the curable group include, but are not limited to, ethylenically unsaturated groups (for example, a (meth)acryloyl group, a vinyl group, and a styryl group) and cyclic ether groups (for example, an epoxy group and an oxetanyl group).

Above all, from the viewpoint that polymerization can be controlled by a radical reaction, the curable group is preferably an ethylenically unsaturated group and more preferably a (meth)acryloyl group.

A polyimide precursor can also be used as the alkali-soluble resin. The polyimide precursor refers to a resin obtained by subjecting a compound containing an acid anhydride group and a diamine compound to an addition polymerization reaction at a temperature of 40° C. to 100° C.

The acid value of the alkali-soluble resin is not particularly limited and is preferably 30 to 500 mgKOH/g and more preferably 50 to 200 mgKOH/g or more.

In a case where the composition contains an alkali-soluble resin, the content of the alkali-soluble resin is preferably 0.1% to 40% by mass, more preferably 0.5% to 30% by mass, and still more preferably 1% to 20% by mass with respect to the total mass of the composition.

### [Solvent]

The composition may contain a solvent. Examples of the solvent include water and an organic solvent, with an organic solvent being preferred.

From the viewpoint of coating properties, a boiling point of the solvent is preferably 100° C. to 400° C., more preferably 150° C. to 300° C., and still more preferably 170° C. to 250° C. In the present specification, the boiling point means a standard boiling point unless otherwise specified.

From the viewpoint that the effect of the present invention is more excellent, the content of the solvent is preferably 1% to 60% by mass, more preferably 2% to 50% by mass, and still more preferably 3% to 40% by mass with respect to the total mass of the composition.

### [Polymerization Initiator]

The composition may contain a polymerization initiator.

The polymerization initiator is not particularly limited, and a known polymerization initiator can be used. Examples of the polymerization initiator include a photopolymerization initiator and a thermal polymerization initiator, with a photopolymerization initiator being preferred. The polymerization initiator is preferably a so-called radical polymerization initiator.

The content of the polymerization initiator in the composition is not particularly limited and is preferably 0.5% to 15% by mass, more preferably 1.0% to 10% by mass, and still more preferably 1.5% to 8.0% by mass with respect to the total solid content of the composition.

In a case where the composition is a positive type photosensitive composition, the composition preferably contains a novolac resin and a quinone diazide group-containing compound.

The novolac resin is a resin obtained by condensation of phenols and aldehydes using an acid catalyst. Examples of the novolac resin include a phenol novolac resin, a cresol novolac resin, a xylinol novolac resin, a resorcinol novolac resin, and a naphthol novolac resin.

The quinone diazide group-containing compound can have, for example, a 1,2-quinone diazide group or a 1,2-naphthoquinone diazide group as a quinone diazide group.

### [Other Optional Components]

The composition may further contain optional components other than the above-mentioned components. Examples of other optional components include a surfactant, a polymerization inhibitor, an antioxidant, a sensitizer, a co-sensitizer, a crosslinking agent (a curing agent, for example, hexamethoxymelamine), a curing accelerator, a heat curing accelerator, a plasticizer, a diluent, an oil sensitizing agent, and a rubber component. Further, known additives such as an adhesion promoter to a substrate surface and other auxiliary agents (for example, an anti-foaming agent, a flame retardant, a leveling agent, a peeling accelerator, a fragrance, a surface tension adjuster, and a chain transfer agent) may be added, if necessary.

### <<Surfactant>>

Examples of the surfactant include various surfactants such as a fluorine-based surfactant, a nonionic surfactant, a cationic surfactant, an anionic surfactant, and a silicone-based surfactant. Examples of the surfactant include surfactants described in paragraphs [0238] to [0245] of WO2015/166779A, the entire contents of which are incorporated herein by reference.

### [Example of Method for Manufacturing Structure]

An example of the method for manufacturing a structure according to the embodiment of the present invention includes the following steps 1 and 2.

Step 1: a step of applying a photosensitive composition containing magnetic particles onto a substrate, a planar inductor, a second insulating layer formed on the planar inductor, or the like to form a composition layer

Step 2: a step of subjecting the composition layer to an exposure treatment and a development treatment to form a first magnetic body portion, a second magnetic body portion, and a third magnetic body portion

Hereinafter, the procedures of steps 1 and 2 will be described in detail.

### [Step 1]

In the step 1, a photosensitive composition containing magnetic particles is applied onto a substrate, a planar inductor, a second insulating layer formed on the planar inductor, or the like to form a composition layer. With regard to the formation position of the composition layer, the composition layer can be formed at the position shown in each example of the structure described above.

The composition used is as described above.

The method for applying the composition is not particularly limited, and examples thereof include various application methods such as a slit coating method, an ink jet method, a spin coating method, a cast coating method, a roll coating method, and a screen printing method.

After the application of the composition, a drying treatment may be carried out, if necessary. The drying (pre-baking) can be carried out, for example, on a hot plate or in an oven at a temperature of 50° C. to 140° C. for 10 to 1800 seconds.

The film thickness of the composition layer is preferably 1 to 10000 μm, more preferably 10 to 1000 μm, and still more preferably 15 to 800 μm.

### (Step 2)

The step 2 is a step of subjecting the composition layer to an exposure treatment and a development treatment to form a first magnetic body portion, a second magnetic body portion, and a third magnetic body portion.

The method of the exposure treatment is not particularly limited, and it is preferable to irradiate the composition layer with light through a photo mask having a patterned opening portion. The patterned opening portion of the photo mask is disposed such that the above-mentioned first magnetic body portion, second magnetic body portion, and third magnetic body portion having predetermined shapes are formed.

The exposure is preferably carried out by irradiation with radiation. The radiation that can be used for exposure is preferably ultraviolet rays such as g-line, h-line, and i-line, and a high-pressure mercury lamp is preferable as a light source. The irradiation intensity is preferably 5 to 1500 mJ/cm² and more preferably 10 to 1000 mJ/cm².

It is preferable to carry out a heat treatment (post-baking) after the exposure treatment. The post-baking is a heat treatment for the completion of curing after the development. The heating temperature is preferably 240° C. or lower and more preferably 220° C. or lower. The lower limit of the heating temperature is not particularly limited and is preferably 50° C. or higher and more preferably 100° C. or higher in consideration of an efficient and effective treatment.

The post-baking can be carried out in a continuous or batchwise manner using a heating unit such as a hot plate, a convection oven (hot air circulation type dryer), or a high frequency heater.

The type of developer used in the development treatment is not particularly limited, and an alkali developer that does not cause damage to a circuit or the like is desirable.

The development temperature is, for example, 20° C. to 30° C.

The development time is, for example, 20 to 90 seconds. In recent years, the development treatment may sometimes be carried out for 120 to 180 seconds in order to more thoroughly remove residues. Further, in order to further improve the removability of residues, a step of shaking off the developer every 60 seconds and then supplying a fresh developer may be repeated several times.

The alkali developer is preferably an alkaline aqueous solution prepared by dissolving an alkaline compound in water so that the concentration of the alkaline compound is 0.001% to 10% by mass (preferably 0.01% to 5% by mass).

Examples of the alkaline compound include sodium hydroxide, potassium hydroxide, sodium carbonate, sodium silicate, sodium metasilicate, aqueous ammonia, ethylamine, diethylamine, dimethylethanolamine, tetramethylammonium hydroxide, tetraethylammonium hydroxide, tetrapropylammonium hydroxide, tetrabutylammonium hydroxide, benzyltrimethylammonium hydroxide, choline, pyrrole, piperidine, and 1,8-diazabicyclo[5.4.0]-7-undecene (among which organic alkalis are preferable.).

In a case where the alkaline aqueous solution is used as the alkali developer, the development is generally followed by a washing treatment with water.

Above all, one example of a suitable aspect of the method for manufacturing a structure according to the embodiment of the present invention is a method for manufacturing a structure, including a step of applying a photosensitive composition containing magnetic particles onto a substrate to form a composition layer; a step of subjecting the composition layer to an exposure treatment and a development treatment to form a first magnetic body portion on the substrate; a step of forming a first insulating layer on the first magnetic body portion; a step of forming a planar inductor having an opening portion on the first insulating layer; a step of applying the photosensitive composition onto the planar inductor to form a composition layer, and subjecting the composition layer to an exposure treatment and a development treatment to form a third magnetic body portion in the opening portion of the planar inductor; a step of forming a second insulating layer on the planar inductor; and a step of applying the photosensitive composition onto the second insulating layer formed on the planar inductor to form a composition layer, and subjecting the composition layer to an exposure treatment and a development treatment to form a second magnetic body portion.

In addition, another example of the suitable aspect of the method for manufacturing a structure according to the embodiment of the present invention is a method for manufacturing a structure, including a step of applying a curable composition containing magnetic particles in a patterned manner onto a substrate to form a first patterned composition layer, and subjecting the first patterned composition layer to a curing treatment to form a first magnetic body portion; a step of forming a first insulating layer on the first magnetic body portion; a step of forming a planar inductor having an opening portion on the insulating layer; a step of applying the curable composition in a patterned manner onto the opening portion of the planar inductor to form a third patterned composition layer, and subjecting the third patterned composition layer to a curing treatment to form a third magnetic body portion; a step of forming a second insulating layer on the planar inductor; and a step of applying the curable composition in a patterned manner onto the second insulating layer formed on the planar inductor to form a second patterned composition layer, and subjecting the second patterned composition layer to a curing treatment to form a second magnetic body portion.

The curable composition used in the above-mentioned method contains a component that can be cured by a curing treatment. Examples of the component that can be cured include the above-mentioned polymerizable compound.

Examples of the method of applying a curable composition in a patterned manner in the above-mentioned method include a screen printing method and an ink jet method.

The type of the curing treatment is not particularly limited, and examples thereof include a thermal curing treatment and a photo curing treatment.

The first patterned composition layer of the above-mentioned method is for forming the above-mentioned first magnetic body portion and has, for example, the same shape as the first magnetic body portion.

The second patterned composition layer is for forming the above-mentioned second magnetic body portion and has, for example, the same shape as the second magnetic body portion.

The third patterned composition layer is for forming the above-mentioned third magnetic body portion and has, for example, the same shape as the third magnetic body portion.

The present invention is basically configured as described above. Although the structure and the method for manufacturing a structure according to the embodiment of the present invention have been described in detail above, the present invention is not limited to the above-mentioned embodiments, and various modifications or changes can be made without departing from the spirit and scope of the present invention.

### EXAMPLES

The features of the present invention will be described in more detail with reference to the following examples. The materials, reagents, amounts and ratios of substances, operations, and the like shown in the following examples can be appropriately changed without departing from the spirit and scope of the present invention. Therefore, the scope of the present invention should not be construed as being limited to the following examples.

In the present example, a configuration in which the planar inductor 14 (see FIG. 1 and FIG. 2) was disposed on a substrate was used. The size of the substrate was 700 μm×300 μm.

The planar inductor 14 was set to have an octagonal outer shape with a maximum outer width of 115 μm and a maximum inner width of 68 μm. The planar inductor 14 has the opening portion 14b similar in shape to the outer shape of the planar inductor 14, and the opening portion is of an octagon. The maximum width of the opening portion was set to 68 m.

The strip-shaped member of the planar inductor 14 was set to have a thickness of 10 m and a width of 10 μm.

The width of an input portion of the planar inductor 14 was set to 10 μm. The number of turns of the planar inductor 14 was set to 2, and a gap between the turns was set to m.

### [Impedance and Volume of Magnetic Body Portion]

In Examples 1 to 21 and Comparative Examples 1 to 15, the change in electromagnetic field of the planar inductor 14 in a case where a voltage of 1 V was applied to the power supply port 14c of the planar inductor 14 and the frequency was changed from 100 MHz to 1000 GHz was calculated. As a result, a relationship between the resonance frequency and the impedance shown in FIG. 3 described above was obtained.

From the graph of the resonance frequency shown in FIG. 3, the inclination of the slope in the low frequency region is taken as L (H), and the maximum value of the peak of the impedance is taken as R (Ω). The frequency at the peak of the impedance is taken as the resonance frequency fr (Hz). The capacitance C (F) was calculated according to the above-mentioned expression from these numerical values. The Q value was calculated according to the above-mentioned expression using R, L, and C.

In addition, the magnetic body volume amounts of the first magnetic body portion, the second magnetic body portion, and the third magnetic body portion were obtained to evaluate the amounts of the magnetic bodies used.

In addition, a ratio of an area occupied by the magnetic body 18c of the third magnetic body portion 18 to an area of the opening portion 14b of the planar inductor 14 was obtained.

The magnetic body volume amount and the ratio of the area of the third magnetic body portion were calculated using the volume integral values and area integral values of the computer aided design (CAD) data of the planar inductor, and the first magnetic body portion, the second magnetic body portion, and the third magnetic body portion used in the simulation.

The shapes of the planar inductor 14, and the first magnetic body portion, the second magnetic body portion, and the third magnetic body portion were designed using AutoDesk Inventor (registered trademark).

The designed CAD data was exported to COMSOL Multiphysics (registered trademark), and in order to obtain the resonance frequency, the frequency dependence of the electric field and the magnetic field was calculated by solving the Helmholtz wave equation shown in Expression (a) and Expression (b) using the physical study of electromagnetic waves (frequency range) in COMSOL Multiphysics (registered trademark).

In Expression (a) and Expression (b), j represents an imaginary number. In Expression (a) and Expression (b), εᵣ=ε′−ε″×j, where ε′ is a real part of a dielectric constant and ε″ is an imaginary part of the dielectric constant.
μr=μ′−μ″×j, where μ′ is a real part of a magnetic permeability and μ″ is an imaginary part of the magnetic permeability.
k₀=ω(μ₀·ε₀)^{1/2} (m⁻¹), where ω is an angular velocity, i is a current, μ₀ is a magnetic permeability in vacuum, and ε₀ is a dielectric constant in vacuum. η₀=(μ₀·ε₀)^{1/2} (Ω)
μ₀=1.257×10⁻⁶ (H/m), and ε₀=8.854×10⁻¹² (F/m).

$$∇ \times ( \frac{∇ \times E}{{μ}_{r}} ) - {k}_{0}^{2} {ε}_{r} E = - {jk}_{0} {η}_{0} i \qquad ( a )$$

$$∇ \times ( \frac{∇ \times H}{{ε}_{r}} ) - {k}_{0}^{2} {μ}_{r} H = ∇ \times ( \frac{i}{{ε}_{r}} ) \qquad ( b )$$

### Examples 1 to 34 and Comparative Examples 1 to 15

Various components were mixed based on the formulations shown in Tables 1 and 2 which will be given later to prepare each of a photosensitive composition and a paste composition. The components used are as follows.

### (Magnetic Particles)

### Barium Ferrite M-1: Synthesized by the Following Method.

400.0 g of water kept at a liquid temperature of 35° C. was stirred, and then a raw material aqueous solution prepared by dissolving 57.0 g of iron (III) chloride hexahydrate [FeCl₃·6H₂O], 25.4 g of barium chloride dihydrate [BaCl₂·2H₂O], and 10.2 g of aluminum chloride hexahydrate [AlCl₃·6H₂O] in 216.0 g of water, and a solution prepared by adding 113.0 g of water to 181.3 g of a sodium hydroxide aqueous solution having a concentration of 5 mol/L were added to the water being stirred at a flow rate of 10 mL/min each at the same timing of addition to obtain a first liquid.

Next, the liquid temperature of the first liquid was set to 25° C. and then, while maintaining this liquid temperature, 39.8 g of a sodium hydroxide aqueous solution having a concentration of 1 mol/L was added to obtain a second liquid. The pH (hydrogen ion exponent) of the obtained second liquid was 10.5±0.5. The pH was measured using a desktop pH meter (F-71, manufactured by Horiba, Ltd.).

Next, the second liquid was stirred for 15 minutes to obtain a liquid containing a precipitate serving as a precursor of magnetoplumbite type hexagonal ferrite (precursor-containing liquid).

Next, the precursor-containing liquid was subjected to a centrifugation treatment (rotation speed: 2000 revolutions per minute (rpm), rotation time: 10 minutes) three times, and the resulting precipitate was recovered and washed with water.

Next, the recovered precipitate was dried in an oven at an internal atmospheric temperature of 95° C. for 12 hours to obtain a powder of the precursor.

Next, the powder of the precursor was placed in a muffle furnace, and the temperature inside the furnace was set to 1100° C. in an air atmosphere and the powder was fired for 4 hours to obtain a lumpy sintered product.

Next, the obtained sintered product was pulverized for 90 seconds using a cutter mill (WONDER CRUSHER WC-3, manufactured by Osaka Chemical Co., Ltd.) as a pulverizer, with a variable speed dial of the pulverizer set to “5” (rotation speed: about 10000 to 15000 rpm), to obtain a magnetic powder (barium ferrite M-1).

The average primary particle diameter of barium ferrite M-1 is 110 nm.

The crystal structure of the magnetic body constituting the above-mentioned magnetic powder was identified by X-ray diffraction analysis. X'Pert Pro (manufactured by Malvern Panalytical Ltd.), which is a powder X-ray diffractometer, was used as a measurement device. The measurement conditions are shown below.

### —Measurement Conditions—

X-ray source: CuKα rays
[wavelength: 1.54 Å (0.154 nm), output: 40 mA, 45 kV]
Scan range: 20°<2θ<70°
Scan interval: 0.05°
Scan speed: 0.75°/min

As a result of the X-ray diffraction analysis, it was confirmed that the obtained magnetic powder was a powder of single-phase magnetoplumbite type hexagonal ferrite having a magnetoplumbite type crystal structure and not containing any crystal structure other than the magnetoplumbite type crystal structure.

### Strontium Ferrite M-2: Synthesized by the Following Method.

46.3 g of strontium carbonate [SrCO₃, manufactured by FUJIFILM Wako Pure Chemical Corporation], 255.1 g of α-iron (III) oxide [α-Fe₂O₃, manufactured by FUJIFILM Wako Pure Chemical Corporation], and 14.8 g of aluminum oxide [Al₂O₃, manufactured by FUJIFILM Wako Pure Chemical Corporation, average particle size: 40 nm] were stirred for 2 minutes using Wonder Crush/Mill (Model: WDL-1, manufactured by Osaka Chemical Co., Ltd.).

300 g of water and 30.0 g of flux (strontium chloride hexahydrate [SrCl₂·6H₂O, manufactured by FUJIFILM Wako Pure Chemical Corporation]) were added to the obtained mixture, which was then stirred for 30 minutes using a Waring blender (Model: 7011HSJ, manufactured by Waring Laboratory Science) and dried in a drying device with an internal atmosphere temperature of 95° C.

Next, the dried mixture was stirred and pulverized for 2 minutes using the Wonder Crush/Mill to obtain a precursor of a magnetic powder. The obtained precursor was placed in a muffle furnace, and the temperature inside the furnace was set to a temperature condition of 1250° C. in an air atmosphere and the precursor was fired for 4 hours to obtain a sintered product. The obtained sintered product was stirred and pulverized for 2 minutes using the Wonder Crush/Mill, repeatedly washed with water, and then dried in a drying device with an internal atmospheric temperature of 95° C.

This was followed by stirring and pulverization for 2 minutes using the Wonder Crush/Mill to obtain a magnetic powder (strontium ferrite M-2).

The average primary particle diameter of strontium ferrite M-2 is 90 nm.

### (Dispersant)

X-1: a resin represented by the following structural formula. The numerical value in each repeating unit in the following formulae represents the content (% by mass) of each repeating unit with respect to all the repeating units.

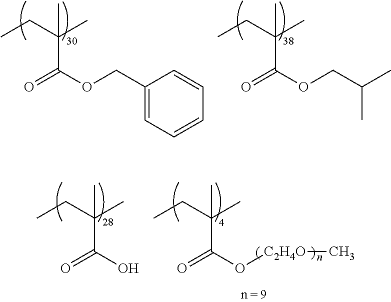

X-2: a resin represented by the following structural formula. The numerical value in each repeating unit in the following formulae represents the content (% by mass) of each repeating unit with respect to all the repeating units.

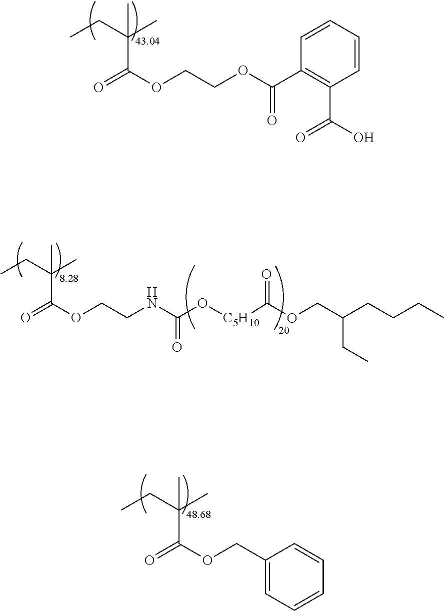

### (Resin)

B-1: a resin represented by the following structural formula. The numerical value in each repeating unit in the following formulae represents the content (% by mass) of each repeating unit with respect to all the repeating units.

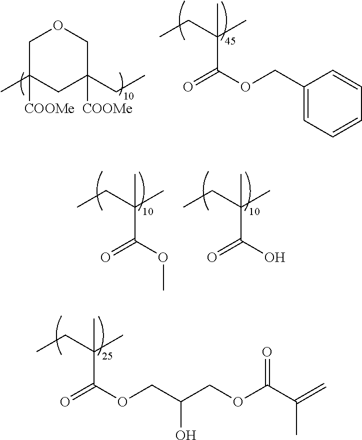

B-2: CYCLOMER P (ACA) 230AA (manufactured by Daicel Corporation)

### (Polymerizable Compound)

C-1: KAYARAD DPHA (a mixture of dipentaerythritol hexaacrylate and dipentaerythritol pentaacrylate, manufactured by Nippon Kayaku Co., Ltd.)
C-2: KAYARAD RP-1040 (tetrafunctional acrylate, manufactured by Nippon Kayaku Co., Ltd.)

### (Polymerization Initiator)

D-1: Irgacure OXE-01 (oxime ester-based initiator, manufactured by BASF SE) (compound (1) having the following structure)

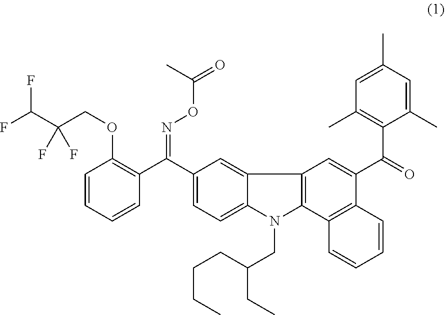 [SMILES: CCCCC(CC)Cn1c2ccc(/C(=N\OC(C)=O)c3ccccc3OCC(F)(F)C(F)F)cc2c2cc(C(=O)c3c(C)cc(C)cc3C)c3ccccc3c21]

D-2: Irgacure OXE-02 (oxime ester-based initiator, manufactured by BASF SE) (compound (2) having the following structure)

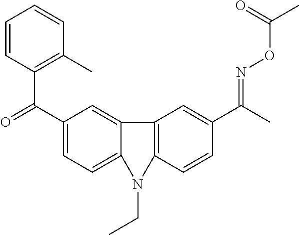 [SMILES: CCn1c2ccc(C(=O)c3ccccc3C)cc2c2cc(/C(C)=N/OC(C)=O)ccc21]

### (Antioxidant)

p-Methoxyphenol (manufactured by Sanritsu Chemy K.K.)
ADEKA STAB AO-80 (a compound having the following structure, manufactured by ADEKA Corporation)

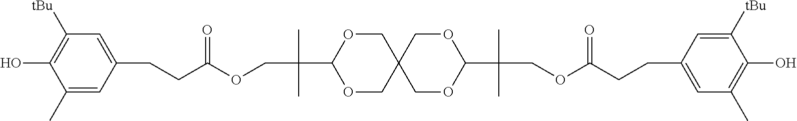 [SMILES: Cc1cc(CCC(=O)OCC(C)(C)C2OCC3(CO2)COC(C(C)(C)COC(=O)CCc2cc(C)c(O)c(C(C)(C)C)c2)OC3)cc(C(C)(C)C)c1O]

### (Surfactant)

KF-6001 (polydimethylsiloxane modified with carbinol at both ends, hydroxyl number: 62 mKOH/o manufactured by Shin-Etsu Chemical Co. Ltd.)
Polyfox PF6320 (a fluorine-based surfactant, manufactured by OMNOVA Solutions Inc.)

### (Solvent)

Propylene glycol monomethyl ether acetate (PGMEA)

### <Compound for Paste Formulation>

P-1: FeMn-based ferrite 1 (concentration of solid contents: 100% by mass, volume average particle diameter: 40 μm)
Fe—Mn-based ferrite P-1: synthesized by the following method.

Using a magnetic material MOSS (manufactured by Powdertech Co., Ltd.), a fine particle formation step was carried out in the same manner as in a case of the barium ferrite M-1 to obtain Fe—Mn-based ferrite P-1.

The average primary particle diameter of Fe—Mn-based ferrite P-1 is 40 μm.

P-2: product name “AW2-08 PF-3F” (Fe-based amorphous alloy particles, manufactured by Epson Atmix Corporation, concentration of solid contents: 100% by mass, volume average particle diameter: 3 μm)

### [Additive 1]

### <Rheology Control Agent>

H-1: product name “FLOWNON RCM-100” (fatty acid ester/aromatic ester, manufactured by Kyoeisha Chemical Co., Ltd., concentration of solid contents: 100% by mass)
H-2: product name “TALEN VA705B” (higher fatty acid amide, manufactured by Kyoeisha Chemical Co., Ltd., concentration of solid contents: 100% by mass)

### [Additive 2]

H-3: product name “HISHICOLIN PX-4MP” (phosphate-based epoxy curing accelerator, manufactured by Nippon Chemical Industrial Co., Ltd.)
H-4: product name “LA-7054” (novolac type phenol resin curing agent, manufactured by DIC Corporation)

### <Dispersant>

X-3: product name “Disperbyk 111” (acidic dispersant, manufactured by BYK-Chemie GmbH, concentration of solid contents: 100% by mass)
X-4: a compound shown below (weight-average molecular weight: 10000) (basic dispersant, synthetic product, concentration of solid contents: 30% by mass (PGMEA solution)). The numerical value attached to each repeating unit of the main chain represents a mass ratio, and the numerical value attached to the side chain represents a repetition number.

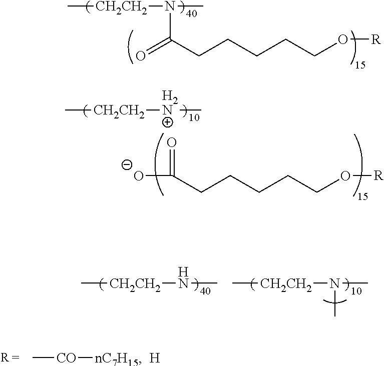

<Epoxy Compound and/or Oxetane Compound>
K-1: product name “CELLOXIDE 2021P” (3′,4′-epoxycyclohexylmethyl 3,4-epoxycyclohexanecarboxylate, manufactured by Daicel Corporation, concentration of solid contents: 100% by mass)
K-2: product name “DENACOL EX-314” (glycerol polyglycidyl ether, manufactured by Nagase ChemteX Corporation, concentration of solid contents: 100% by mass)

### [Solvent]

G-1: propylene glycol monomethyl ether acetate (PGMEA)
G-2: glycerol triacetate (manufactured by FUJIFILM Wako Pure Chemical Corporation)
G-3: cyclohexanone (manufactured by FUJIFILM Wako Pure Chemical Corporation)

The composition prepared above was applied onto a substrate to form a composition layer. Then, the composition layer was subjected to a drying treatment at 100° C. for 2 minutes.

The thickness of the composition layer was adjusted by adjusting the application amount of the composition such that the film thickness of the first magnetic body portion was m. The substrate was a silicon substrate.

Next, the composition layer was subjected to an exposure treatment under the condition of 10 mJ/cm² using a simple USHIO exposure device through a photo mask having a predetermined opening portion so that the first magnetic body portion 16 as shown in FIG. 4 was formed.

After the exposure, a shower development treatment was carried out at 23° C. for 60 seconds using a simple development device (manufactured by Mikasa Corporation). An aqueous solution having a content of tetramethylammonium hydroxide (TMAH) of 0.3% by mass was used as the developer.

After the development, a rinsing treatment by spin showering using pure water was carried out, followed by spin drying and then a heat treatment (post-baking) for 5 minutes using a hot plate at 220° C. to form a first magnetic body portion having a predetermined shape.

Similarly to the first magnetic body portion, the second magnetic body portion and the third magnetic body portion were formed in positions and shapes according to the configuration of the structure.

The prepared paste composition was applied onto a substrate so that the first magnetic body portion 16 as shown in FIG. 4 was formed, thereby forming a composition layer. As described above, the thickness of the composition layer was adjusted by adjusting the application amount of the composition such that the film thickness of the first magnetic body portion was 10 μm.

A slit coating method was used as the method of applying the paste composition onto the substrate. After the application of the composition, a drying treatment was carried out as necessary. The drying (pre-baking) was carried out in an oven at a temperature of 50° C. to 140° C. for 10 to 1800 seconds.

### Examples 1 to 34

A structure having a first magnetic body portion, a second magnetic body portion, and a third magnetic body portion was manufactured according to the same procedure as described above, except that the patterns of the first magnetic body portion, the second magnetic body portion, and the third magnetic body portion were made as described later, and the photosensitive compositions or paste compositions for forming the first magnetic body portion, the second magnetic body portion, and the third magnetic body portion were prepared based on the formulations shown in Tables 1 and 2 which will be give later.

Example 1 was set to have Formulation 1, and the disposition of the first magnetic body portion, the second magnetic body portion, and the third magnetic body portion was set to the disposition shown in FIG. 20 and FIG. 21.

Example 2 was set to have Formulation 1, and the disposition of the first magnetic body portion, the second magnetic body portion, and the third magnetic body portion was set to the disposition shown in FIG. 22.

Example 3 was set to have Formulation 1, and the disposition of the first magnetic body portion, the second magnetic body portion, and the third magnetic body portion was set to the disposition shown in FIG. 23.

Example 4 was set to have Formulation 1, and the disposition of the first magnetic body portion, the second magnetic body portion, and the third magnetic body portion was set to the disposition shown in FIG. 24.

Example 5 was set to have Formulation 1, and the disposition of the first magnetic body portion, the second magnetic body portion, and the third magnetic body portion was set to the disposition shown in FIG. 25.

Example 6 was set to have Formulation 2, and the disposition of the first magnetic body portion, the second magnetic body portion, and the third magnetic body portion was set to the disposition shown in FIG. 25.

Example 7 was set to have Formulation 3, and the disposition of the first magnetic body portion, the second magnetic body portion, and the third magnetic body portion was set to the disposition shown in FIG. 25.

Example 8 was set to have Formulation 4, and the disposition of the first magnetic body portion, the second magnetic body portion, and the third magnetic body portion was set to the disposition shown in FIG. 25.

Example 9 was set to have Formulation 5, and the disposition of the first magnetic body portion, the second magnetic body portion, and the third magnetic body portion was set to the disposition shown in FIG. 25.

Example 10 was set to have Formulation 6, and the disposition of the first magnetic body portion, the second magnetic body portion, and the third magnetic body portion was set to the disposition shown in FIG. 25.

Example 11 was set to have Formulation 7, and the disposition of the first magnetic body portion, the second magnetic body portion, and the third magnetic body portion was set to the disposition shown in FIG. 25.

Example 12 was set to have Formulation 8, and the disposition of the first magnetic body portion, the second magnetic body portion, and the third magnetic body portion was set to the disposition shown in FIG. 25.

Example 13 was set to have Formulation 9, and the disposition of the first magnetic body portion, the second magnetic body portion, and the third magnetic body portion was set to the disposition shown in FIG. 25.

Example 14 was set to have Formulation 1, and the disposition of the first magnetic body portion, the second magnetic body portion, and the third magnetic body portion was set to the disposition shown in FIG. 26.

Example 15 was set to have Formulation 10, and the disposition of the first magnetic body portion, the second magnetic body portion, and the third magnetic body portion was set to the disposition shown in FIG. 26.

Example 16 was set to have Formulation 11, and the disposition of the first magnetic body portion, the second magnetic body portion, and the third magnetic body portion was set to the disposition shown in FIG. 26.

Example 17 was set to have Formulation 12, and the disposition of the first magnetic body portion, the second magnetic body portion, and the third magnetic body portion was set to the disposition shown in FIG. 26.

Example 18 was set to have Formulation 13, and the disposition of the first magnetic body portion, the second magnetic body portion, and the third magnetic body portion was set to the disposition shown in FIG. 26.

Example 19 was set to have Formulation 14, and the disposition of the first magnetic body portion, the second magnetic body portion, and the third magnetic body portion was set to the disposition shown in FIG. 26.

Example 20 was set to have Formulation 15, and the disposition of the first magnetic body portion, the second magnetic body portion, and the third magnetic body portion was set to the disposition shown in FIG. 26.

Example 21 was set to have Formulation 1, and the first magnetic body portion, the second magnetic body portion, and the third magnetic body portion were configured as shown in FIG. 20, such that the extending portion of the first magnetic body portion and the extending portion of the second magnetic body portion were not disposed between the two strip-shaped members connected to the power supply port of the planar inductor. That is, Example 21 had a configuration in which the extending portion of the first magnetic body portion and the extending portion of the second magnetic body portion were not disposed between the two strip-shaped members connected to the power supply port of the planar inductor in Example 1. Example 21 has a configuration in which the connecting portion 30 is not provided in the structure 10h shown in FIG. 28.

Example 22 was set to have Formulation 1, and the first magnetic body portion, the second magnetic body portion, and the third magnetic body portion were configured to have no connecting portion 30 in the structure 10i shown in FIG. 29. That is, Example 22 had a configuration in which the extending portion of the first magnetic body portion and the extending portion of the second magnetic body portion were not disposed between the two strip-shaped members connected to the power supply port of the planar inductor in Example 2.

In Example 23, the first magnetic body portion, the second magnetic body portion, and the third magnetic body portion were configured to have no connecting portion 30 in the structure 10j shown in FIG. 30. That is, Example 23 had a configuration in which the extending portion of the first magnetic body portion and the extending portion of the second magnetic body portion were not disposed between the two strip-shaped members connected to the power supply port of the planar inductor in Example 3.

In Example 24, the first magnetic body portion, the second magnetic body portion, and the third magnetic body portion were configured to have no connecting portion 30 in the structure 10k shown in FIG. 31. That is, Example 24 had a configuration in which the extending portion of the first magnetic body portion and the extending portion of the second magnetic body portion were not disposed between the two strip-shaped members connected to the power supply port of the planar inductor in Example 4.

In Example 25, the first magnetic body portion, the second magnetic body portion, and the third magnetic body portion were configured as shown in FIG. 25, such that the extending portion of the first magnetic body portion and the extending portion of the second magnetic body portion were not disposed between the two strip-shaped members connected to the power supply port of the planar inductor. That is, Example 25 had a configuration in which the extending portion of the first magnetic body portion and the extending portion of the second magnetic body portion were not disposed between the two strip-shaped members connected to the power supply port of the planar inductor in Example 5.

In Example 26, the disposition of the first magnetic body portion, the second magnetic body portion, and the third magnetic body portion was set to the disposition shown in FIG. 27.

In Example 27, the disposition of the first magnetic body portion, the second magnetic body portion, and the third magnetic body portion was set to the disposition shown in FIG. 28.

In Example 28, the disposition of the first magnetic body portion, the second magnetic body portion, and the third magnetic body portion was set to the disposition shown in FIG. 29.

In Example 29, the disposition of the first magnetic body portion, the second magnetic body portion, and the third magnetic body portion was set to the disposition shown in FIG. 30.

In Example 30, the disposition of the first magnetic body portion, the second magnetic body portion, and the third magnetic body portion was set to the disposition shown in FIG. 31.

In Example 31, the disposition of the first magnetic body portion, the second magnetic body portion, and the third magnetic body portion was set to the disposition shown in FIG. 32.

In Example 32, the disposition of the first magnetic body portion, the second magnetic body portion, and the third magnetic body portion was set to the disposition shown in FIG. 33.

In Example 33, the disposition of the first magnetic body portion, the second magnetic body portion, and the third magnetic body portion was set to the disposition shown in FIG. 34.

In Example 34, the disposition of the first magnetic body portion, the second magnetic body portion, and the third magnetic body portion was set to the disposition shown in FIG. 35.

### Comparative Examples 1 to 15

Comparative Example 1 had a configuration in which the first magnetic body portion, the second magnetic body portion, and the third magnetic body portion were not provided, and was configured with only the planar inductor 14 as shown in FIG. 2.

In Comparative Example 2, a structure 100 was configured such that a third magnetic body portion 102 was disposed only in the opening portion 14b of the planar inductor 14 as shown in FIG. 36. In Comparative Example 2, the third magnetic body portion 102 was configured to have a single layer structure.

In FIG. 36 to FIG. 41, the same components as those of the structure 10 shown in FIG. 1 and FIG. 2 are denoted by the same reference numerals, and the detailed description thereof will be omitted. In addition, the substrate 12, the interlayer insulating layer 15b of the first insulating layer 15, and the second insulating layer 19 shown in FIG. 1 are not shown in FIG. 36 to FIG. 41.

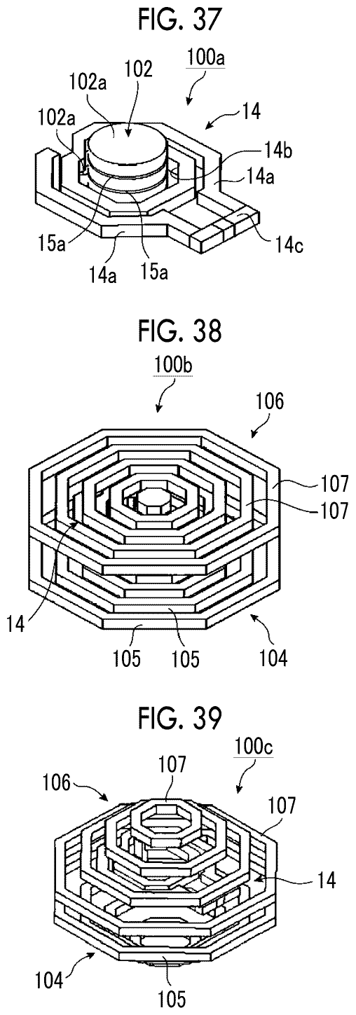

In Comparative Example 3, the disposition of the third magnetic body portion 102 was set to the disposition shown in FIG. 37. In a structure 100a shown in Comparative Example 3, the third magnetic body portion 102 was configured to have a 5-layer structure. The third magnetic body portion 102 of Comparative Example 3 is formed by laminating five magnetic bodies 102a. The shield insulating layer 15a is disposed between the magnetic bodies 102a, and the magnetic bodies 102a are electrically insulated from each other.

In Comparative Example 4, the disposition of the third magnetic body portion 102 was such that the third magnetic body portion 102 was configured to have a 9-layer structure in the disposition shown in FIG. 37.

In Comparative Example 5, the disposition of the third magnetic body portion 102 was such that the third magnetic body portion 102 was configured to have a 13-layer structure in the disposition shown in FIG. 37.

In Comparative Example 6, the disposition of the third magnetic body portion 102 was such that the third magnetic body portion 102 was configured to have a 17-layer structure in the disposition shown in FIG. 37.

Comparative Example 7 had a configuration in which the third magnetic body portion was not provided, and the disposition of the first magnetic body portion and the second magnetic body portion was set to the disposition shown in FIG. 32.

Comparative Example 8 had a configuration in which the third magnetic body portion was not provided, and the disposition of the first magnetic body portion and the second magnetic body portion was set to the disposition shown in FIG. 38.

In a structure 100b shown in FIG. 38, a first magnetic body portion 104 is composed of a plurality of octagonal members 105 having similar outer shapes but different sizes, and a second magnetic body portion 106 is composed of a plurality of octagonal members 107 having similar outer shapes but different sizes.

The first magnetic body portion 104 has a plurality of members 105 having an octagonal outer shape disposed so that centers of the members 105 coincide with each other. The second magnetic body portion 106 has a plurality of members 107 having an octagonal outer shape disposed so that centers of the members 107 coincide with each other.

Comparative Example 9 had a configuration in which the third magnetic body portion was not provided, and the disposition of the first magnetic body portion 104 and the second magnetic body portion 106 was set to the disposition shown in FIG. 39. In a structure 100c shown in FIG. 39, the first magnetic body portion 104 is composed of a plurality of octagonal members 105 having similar outer shapes but different sizes. The plurality of members 105 are disposed to be shifted in an up-down direction with the centers of the members 105 coinciding with each other and the member having a large outer shape facing the planar inductor 14 side. The second magnetic body portion 106 is also composed of a plurality of octagonal members 107 having similar outer shapes but different sizes. The plurality of members 107 are disposed to be shifted in an up-down direction with the centers of the members 107 coinciding with each other and the member having a large outer shape facing the planar inductor 14 side. In the structure 100c, the planar inductor 14 is surrounded by the first magnetic body portion 104 and the second magnetic body portion 106.

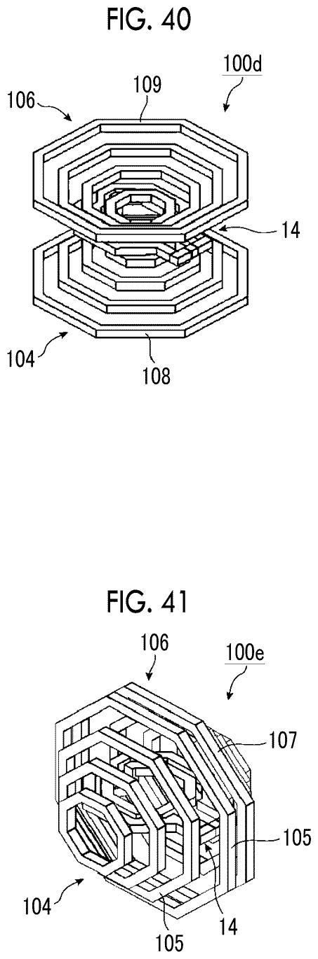

In Comparative Example 10, the third magnetic body portion was not provided, and the disposition of the first magnetic body portion 104 and the second magnetic body portion 106 was set to the disposition shown in FIG. 40. In a structure 100d shown in FIG. 40, the first magnetic body portion 104 is composed of a plurality of octagonal members 108 having similar outer shapes but different sizes. The plurality of members 108 are disposed to be shifted in an up-down direction with the centers of the members 108 coinciding with each other and the member having a small outer shape facing the planar inductor 14 side. The second magnetic body portion 106 is also composed of a plurality of octagonal members 109 having similar outer shapes but different sizes. The plurality of members 109 are disposed to be shifted in an up-down direction with the centers of the members 109 coinciding with each other and the member having a small outer shape facing the planar inductor 14 side.

In Comparative Example 11, the third magnetic body portion was not provided, and the disposition of the first magnetic body portion 104 and the second magnetic body portion 106 was set to the disposition shown in FIG. 41. In a structure 100e shown in FIG. 41, the first magnetic body portion 104 and the second magnetic body portion 106 of the structure 100c shown in FIG. 39 were rotated by 90° and were placed in an upright state.

Comparative Example 12 had a configuration in which the third magnetic body portion of Example 21 was not provided.

Comparative Example 13 had a configuration in which the third magnetic body portion of Example 22 was not provided.

Comparative Example 14 had a configuration in which the third magnetic body portion of Example 25 was not provided.

Comparative Example 15 had a configuration in which the third magnetic body portion of Example 26 was not provided.

The magnetic permeability of each of the first magnetic body portion, the second magnetic body portion, and the third magnetic body portion was measured in a range of 0.1 to 20 GHz using a high-frequency magnetic permeability measuring device (Model No. PER01, manufactured by KEYCOM Corporation). For the magnetic permeability, the values of “μ′ (real part)” and “μ” (imaginary part) at 50 MHz, 5 GHz, and 20 Hz were extracted. The magnetic permeability of each of the first magnetic body portion, the second magnetic body portion, and the third magnetic body portion was in a range of 1 to 25.

For Examples 1 to 34 and Comparative Examples 1 to 15 described above, the magnetic body volume amount, the Q value, the inductance ratio, the resonance frequency ratio, and the ratio of the area occupied by the third magnetic body portion were obtained.

In Table 3 to Table 5 which will be given later, the magnetic body volume amount is referred to as “MM amount”, the inductance ratio is referred to as “L/L0”, the resonance frequency ratio is referred to as “fr/fr0”, and the ratio of the area occupied by the third magnetic body portion is referred to as “Space ratio of third magnetic body portion”. In addition, since Comparative Example 1 had a configuration in which the magnetic body portion was not provided, “None” was written in the columns of “MM amount” and “Space ratio of third magnetic body portion”.

In addition, L0 in the inductance ratio and the resonance frequency fr0 in the resonance frequency ratio were obtained using the values of the inductance and the resonance frequency of Comparative Example 1 with Comparative Example 1 as a reference.

The MM amount was evaluated according to the following evaluation standards.
A: The MM amount is less than 3×10⁻⁴ (mm³).
B: The MM amount is 3×10⁻⁴ or more and 5×10⁻⁴ (mm³) or less.
C: The MM amount is more than 5×10⁻⁴ (mm³).

The Q value was evaluated according to the following evaluation standards.
A: The Q value is more than 30.
B: The Q value is 20 or more and 30 or less.
C: The Q value is less than 20.

The inductance ratio (L/L0) was evaluated according to the following evaluation standards.
A: L/L0 is more than 1.5.
B: L/L0 is 1.1 or more and 1.5 or less
C: L/L0 is less than 1.1

The resonance frequency ratio (fr/fr0) was evaluated according to the following evaluation standards.
A: fr/fr0 is less than 0.65
B: fr/fr0 is 0.65 or more and 0.75 or less.
C: fr/fr0 is more than 0.75.

TABLE 1

| Formulation | | | Photosensitivity formulation | | | | | | | | |
|---|---|---|---|---|---|---|---|---|---|---|---|
| Classification | Compound | | 1 | 2 | 3 | 4 | 5 | 6 | 7 | 8 | 9 |
| Magnetic body | Barium ferrite | M-1 | 24.86% | | 24.86% | 24.86% | 24.86% | 24.86% | 24.86% | 24.86% | 24.86% |
| | Strontium ferrite | M-2 | | 24.86% | | | | | | | |
| | FeMn-based ferrite 1 (concentration | P-1 | | | | | | | | | |
| | of solid contents: 100% by | | | | | | | | | | |
| | mass, volume average | | | | | | | | | | |
| | particle diameter: 40 μm) | | | | | | | | | | |
| | “AW2-08 PF-3F” (Fe-based | P-2 | | | | | | | | | |
| | amorphous alloy particles, | | | | | | | | | | |
| | manufactured by Epson | | | | | | | | | | |
| | Atmix Corporation) | | | | | | | | | | |
| Dispersant | Synthetic product | X-1 | 22.38% | 22.38% | | 22.38% | 22.38% | 22.38% | 22.38% | 22.38% | 22.38% |
| | Synthetic product | X-2 | | | 22.38% | | | | | | |
| | “Disperbyk 111” (acidic | X-3 | | | | | | | | | |
| | dispersant, manufactured by | | | | | | | | | | |
| | BYK-Chemie GmbH) | | | | | | | | | | |
| | Synthetic product | X-4 | | | | | | | | | |
| Resin | Synthetic product | B-1 | 0.10% | 0.0% | 0.10% | | 0.10% | 0.10% | 0.0% | 0.10% | 0.10% |
| | CYCLOMER P (ACA) | B-2 | | | | 0.10% | | | | | |
| | 230AA (manufactured by Daicel | | | | | | | | | | |
| | Corporation) | | | | | | | | | | |
| Polymerizable | KAYARAD DPHA (manufactured | C-1 | 17.08% | 17.08% | 17.08% | 17.08% | | 17.08% | 17.08% | 17.08% | 17.08% |
| compound | by Nippon Kayaku Co., Ltd.) | | | | | | | | | | |
| | KAYARAD RP-1040 | C-2 | | | | | 17.08% | | | | |
| | (manufactured by Nippon Kayaku Co., | | | | | | | | | | |
| | Ltd., tetrafunctional acrylate) | | | | | | | | | | |
| Photopoly- | Irgacure OXE-01 (manufactured | D-1 | 6.98% | 6.98% | 6.98% | 6.98% | 6.98% | | 6.98% | 6.98% | 6.98% |
| merization | by BASF SE) | | | | | | | | | | |
| initiator | Irgacure OXE-02 (manufactured | D-2 | | | | | | 6.98% | | | |
| | by BASF SE) | | | | | | | | | | |
| Antioxidant | p-Methoxyphenol (manufactured | E-1 | 0.01% | 0.01% | 0.01% | 0.01% | 0.01% | 0.01% | | 0.01% | 0.01% |
| | by Sanritsu Chemy K.K.) | | | | | | | | | | |
| | ADEKA STAB AO-80 (manufactured | E-2 | | | | | | | 0.01% | | |
| | by ADEKA Corporation) | | | | | | | | | | |
| Surfactant | KF-6001 (manufactured by | F-1 | 0.01% | 0.01% | 0.01% | 0.01% | 0.01% | 0.01% | 0.01% | | 0.01% |
| | Shin-Etsu Chemical Co., Ltd.) | | | | | | | | | | |
| | Polyfox PF6320 (manufactured | F-2 | | | | | | | | 0.01% | |
| | by OMNOVA Solutions Inc.) | | | | | | | | | | |
| Solvent | PGMEA (propylene glycol | G-1 | 28.58% | 28.58% | 28.58% | 28.58% | 28.58% | 28.58% | 28.58% | 28.58% | 25.72% |
| | monomethyl ether acetate) | | | | | | | | | | |
| | Glycerol triacetate (manufactured | G-2 | | | | | | | | | |
| | by FUJIFILM Wako Pure | | | | | | | | | | |
| | Chemical Corporation) | | | | | | | | | | |
| | Cyclohexanone (manufactured | G-3 | | | | | | | | | 2.86% |
| | by FUJIFILM Wako Pure | | | | | | | | | | |
| | Chemical Corporation) | | | | | | | | | | |
| Additive 1 | FLOWNON RCM-100 | H-1 | | | | | | | | | |
| | (fatty acid ester/aromatic ester, | | | | | | | | | | |
| | manufactured by Kyoeisha | | | | | | | | | | |
| | Chemical Co., Ltd.) | | | | | | | | | | |
| | TALEN VA705B (higher fatty | H-2 | | | | | | | | | |
| | acid amide, manufactured by | | | | | | | | | | |
| | Kyoeisha Chemical Co., Ltd.) | | | | | | | | | | |
| Additive 2 | “HISHICOLIN PX-4MP” | H-3 | | | | | | | | | |
| | (phosphate-based epoxy curing | | | | | | | | | | |
| | accelerator, manufactured by | | | | | | | | | | |
| | Nippon Chemical Industrial Co., | | | | | | | | | | |
| | Ltd.) | | | | | | | | | | |
| | LA-7054 (novolac type phenol | H-4 | | | | | | | | | |
| | resin curing agent, manufactured | | | | | | | | | | |
| | by DIC Corporation) | | | | | | | | | | |
| Epoxy | “CELLOXIDE 2021P” | K-1 | | | | | | | | | |
| compound | (3′,4′-epoxycyclohexylmethyl | | | | | | | | | | |
| | 3,4-epoxycyclohexanecarboxylate, | | | | | | | | | | |
| | manufactured by Daicel | | | | | | | | | | |
| | Corporation) | | | | | | | | | | |
| | “DENACOL EX-314” (glycerol | K-2 | | | | | | | | | |
| | polyglycidyl ether, manufactured | | | | | | | | | | |
| | by Nagase ChemteX Corporation) | | | | | | | | | | |

TABLE 2

| Formulation | | | Paste formulation | | | | | |
|---|---|---|---|---|---|---|---|---|
| Classification | Compound | | 10 | 11 | 12 | 13 | 14 | 15 |
| Magnetic body | Barium ferrite | M-1 | | | | | | |
| | Strontium ferrite | M-2 | | | | | | |
| | FeMn-based ferrite 1 (concentration | P-1 | 42.80% | 42.80% | 42.80% | 42.80% | 42.80% | 42.80% |
| | of solid contents: 100% by mass, volume | | | | | | | |
| | average particle diameter: 40 μm) | | | | | | | |
| | “AW2-08 PF-3F” (Fe-based amorphous | P-2 | 42.80% | 42.80% | 42.80% | 42.80% | 42.805 | 42.80% |
| | alloy particles, manufactured by Epson | | | | | | | |
| | Atmix Corporation) | | | | | | | |
| Dispersant | Synthetic product | X-1 | | | | | | |
| | Synthetic product | X-2 | | | | | | |
| | “Disperbyk 111” (acidic dispersant, | X-3 | | 1.99% | | | | |
| | manufactured by BYK-Chemie GmbH) | | | | | | | |
| | Synthetic product | X-4 | 1.99% | | 1.99% | 1.99% | 1.99% | 1.99% |
| Resin | Synthetic product | B-1 | | | | | | |
| | CYCLOMER P (ACA) 230AA | B-2 | | | | | | |
| | (manufactured by Daicel Corporation) | | | | | | | |
| Polymerizable | KAYARAD DPHA (manufactured | C-1 | | | | | | |
| compound | by Nippon Kayaku Co., Ltd.) | | | | | | | |
| | KAYARAD RP-1040 (manufactured by | C-2 | | | | | | |
| | Nippon Kayaku Co., Ltd., tetrafunctional | | | | | | | |
| | acrylate) | | | | | | | |
| Photopolymerization | Irgacure OXE-01 (manufactured by BASF SE) | D-1 | | | | | | |
| initiator | Irgacure OXE-02 (manufactured by BASF SE) | D-2 | | | | | | |
| Antioxidant | p-Methoxyphenol (manufactured | E-1 | | | | | | |
| | by Sanritsu Chemy K.K.) | | | | | | | |
| | ADEKA STAB AO-80 (manufactured | E-2 | | | | | | |
| | by ADEKA Corporation) | | | | | | | |
| Surfactant | KF-6001 (manufactured by | F-1 | | | | | | |
| | Shin-Etsu Chemical Co., Ltd.) | | | | | | | |
| | Polyfox PF6320 (manufactured | F-2 | | | | | | |
| | by OMNOVA Solutions Inc.) | | | | | | | |
| Solvent | PGMEA (propylene glycol | G-1 | | | | | | |
| | monomethyl ether acetate) | | | | | | | |
| | Glycerol triacetate (manufactured by | G-2 | 6.57% | 6.57% | 6.57% | 6.57% | 6.57% | |
| | FUJIFILM Wako Pure Chemical Corporation) | | | | | | | |
| | Cyclohexanone (manufactured by | G-3 | | | | | | 6.57% |
| | FUJIFILM Wako Pure Chemical Corporation) | | | | | | | |
| Additive 1 | FLOWNON RCM-100 | H-1 | 0.30% | 0.30% | | 0.30% | 0.30% | 0.30% |
| | (fatty acid ester/aromatic | | | | | | | |
| | ester, manufactured by Kyoeisha | | | | | | | |
| | Chemical Co., Ltd.) | | | | | | | |
| | TALEN VA705B (higher fatty acid amide, | H-2 | | | 0.30% | | | |
| | manufactured by Kyoeisha Chemical Co., | | | | | | | |
| | Ltd.) | | | | | | | |
| Additive 2 | “HISHICOLIN PX-4MP” (phosphate-based | H-3 | 0.46% | 0.46% | 0.46% | | 0.46% | 0.46% |
| | epoxy curing accelerator, manufactured | | | | | | | |
| | by Nippon Chemical Industrial Co., Ltd.) | | | | | | | |
| | LA-7054 (novolac type phenol resin | H-4 | | | | 0.46% | | |
| | curing agent, manufactured by DIC | | | | | | | |
| | Corporation) | | | | | | | |
| Epoxy compound | “CELLOXIDE 2021P” | K-1 | | | | | 5.08% | |
| | (3′,4′-epoxycyclohexylmethyl | | | | | | | |
| | 3,4-epoxycyclohexanecarboxylate, | | | | | | | |
| | manufactured by Daicel Corporation) | | | | | | | |
| | “DENACOL EX-314” (glycerol polyglycidyl | K-2 | 5.08% | 5.08% | 5.08% | 5.08S | | 5.08% |
| | ether, manufactured by Nagase | | | | | | | |
| | ChemteX Corporation) | | | | | | | |

TABLE 3

| | | | | | | Space ratio of |
|---|---|---|---|---|---|---|
| | For- | MM | | | | third magnetic |
| | mulation | amount | Q value | L/L0 | fr/fr0 | body portion |
| Example 1 | 1 | A | A | B | B | 59.6% |
| Example 2 | 1 | A | B | A | B | 59.6% |
| Example 3 | 1 | A | B | A | B | 59.6% |
| Example 4 | 1 | A | B | A | A | 59.6% |
| Example 5 | 1 | A | B | A | A | 59.6% |
| Example 6 | 2 | A | B | A | A | 59.6% |
| Example 7 | 3 | A | B | A | A | 59.6% |
| Example 8 | 4 | A | B | A | A | 59.6% |
| Example 9 | 5 | A | B | A | A | 59.6% |
| Example | 6 | A | B | A | A | 59.6% |
| 10 | | | | | | |
| Example | 7 | A | B | A | A | 59.6% |
| 11 | | | | | | |
| Example | 8 | A | B | A | A | 59.6% |
| 12 | | | | | | |
| Example | 9 | A | B | A | A | 59.6% |
| 13 | | | | | | |
| Example | 1 | B | A | A | A | 59.6% |
| 14 | | | | | | |
| Example | 10 | B | A | A | A | 59.6% |
| 15 | | | | | | |
| Example | 11 | B | A | A | A | 59.6% |
| 16 | | | | | | |
| Example | 12 | B | A | A | A | 59.6% |
| 17 | | | | | | |

TABLE 4

| | | | | | | Space ratio of |
|---|---|---|---|---|---|---|
| | For- | MM | | | | third magnetic |
| | mulation | amount | Q value | L/L0 | fr/fr0 | body portion |
| Example | 13 | B | A | A | A | 59.6% |
| 18 | | | | | | |
| Example | 14 | B | A | A | A | 59.6% |
| 19 | | | | | | |
| Example | 15 | B | A | A | A | 59.6% |
| 20 | | | | | | |
| Example | 1 | A | A | B | B | 59.6% |
| 21 | | | | | | |
| Example | 1 | A | A | B | B | 59.6% |
| 22 | | | | | | |
| Example | 1 | A | A | B | B | 59.6% |
| 23 | | | | | | |
| Example | 1 | A | A | B | A | 59.6% |
| 24 | | | | | | |
| Example | 1 | B | B | A | A | 59.6% |
| 25 | | | | | | |
| Example | 1 | B | B | A | A | 59.6% |
| 26 | | | | | | |
| Example | 1 | A | A | B | B | 59.6% |
| 27 | | | | | | |
| Example | 1 | A | A | B | B | 59.6% |
| 28 | | | | | | |
| Example | 1 | A | B | A | B | 59.6% |
| 29 | | | | | | |
| Example | 1 | B | A | B | A | 59.6% |
| 30 | | | | | | |
| Example | 1 | B | A | A | A | 67.0% |
| 31 | | | | | | |
| Example | 1 | A | B | B | A | 25.5% |
| 32 | | | | | | |
| Example | 1 | A | B | B | A | 25.5% |
| 33 | | | | | | |
| Example | 1 | A | B | B | A | 25.5% |
| 34 | | | | | | |

TABLE 5

| | | | | | | Space |
|---|---|---|---|---|---|---|
| | | | | | | ratio |
| | | | | | | of third |
| | | | | | | magnetic |
| | For- | MM | Q | | | body |
| | mulation | amount | value | L/L0 | fr/fr0 | portion |
| Comparative | None | None | A | Reference | Reference | None |
| Example 1 | | | | | | |
| Comparative | 1 | A | A | C | C | 59.6% |
| Example 2 | | | | | | |
| Comparative | 1 | A | A | C | C | 59.6% |
| Example 3 | | | | | | |
| Comparative | 1 | A | A | C | C | 59.6% |
| Example 4 | | | | | | |
| Comparative | 1 | A | A | C | C | 59.6% |
| Example 5 | | | | | | |
| Comparative | 1 | B | A | C | C | 59.6% |
| Example 6 | | | | | | |
| Comparative | 1 | B | A | B | C | 0.0% |
| Example 7 | | | | | | |
| Comparative | 1 | B | A | B | C | 0.0% |
| Example 8 | | | | | | |
| Comparative | 1 | B | A | C | C | 0.0% |
| Example 9 | | | | | | |
| Comparative | 1 | B | A | C | C | 0.0% |
| Example 10 | | | | | | |
| Comparative | 1 | B | A | C | C | 0.0% |
| Example 11 | | | | | | |
| Comparative | 1 | A | A | C | C | 0.0% |
| Example 12 | | | | | | |
| Comparative | 1 | A | A | B | C | 0.0% |
| Example 13 | | | | | | |
| Comparative | 1 | A | A | B | C | 0.0% |
| Example 14 | | | | | | |
| Comparative | 1 | B | A | B | C | 0.0% |
| Example 15 | | | | | | |

As shown in Table 3 to Table 5, the Q values themselves are high in Examples 1 to 34. In addition, the inductance ratio (L/L0) is larger and the resonance frequency ratio (fr/fr0) is smaller in Examples 1 to 34 than in Comparative Examples 1 to 15, so it is clear that the size of the planar inductor can be reduced.

As in Examples 14 and 31, the first magnetic body portion and the second magnetic body portion were made as the flat plate portion, so that the volume of the magnetic body was increased, but the Q value, the inductance ratio (L/L0), and the resonance frequency ratio (fr/fr0) were all evaluated as “A”.

From Examples 1 to 20, Examples 21 to 26, and Examples 27 to 31, as the shape of the first magnetic body portion and the second magnetic body portion approached the flat plate portion, such as by increasing the extending portion, the inductance ratio (L/L0) tended to be large and the resonance frequency ratio (fr/fr0) tended to be small.

### EXPLANATION OF REFERENCES

10, 10a, 10b, 10c, 10d, 10e, 10f, 10g, 10h, 10i, 10j, 10k, 10m, 10n, 10p, 10q: structure
12: substrate
12a: surface
14: planar inductor
14a: strip-shaped member
14b: opening portion
14c: power supply port
15: first insulating layer
16, 104: first magnetic body portion
16a: first center portion
16b, 17b: extending portion
16c, 17c: notched portion
17: second magnetic body portion
17a: second center portion
18, 102: third magnetic body portion
18a, 18b, 18c: magnetic body
19: second insulating layer
20: magnetic body portion
21, 24, 25: composition layer
22, 26: photo mask
23a, 27a: region
23b, 27b: mask portion
30: connecting portion
105, 107, 108, 109: member
100, 100a, 100b, 100c, 100d, 100e: structure
Cd: center
Lv: exposure light

What is claimed is:

1. A structure comprising:
a substrate; and
a planar inductor disposed on the substrate,
wherein the structure further includes a first magnetic body portion disposed on a substrate side with respect to the planar inductor with a first insulating layer interposed therebetween,
a second magnetic body portion disposed on a side opposite to the substrate side with respect to the planar inductor with a second insulating layer interposed therebetween, and
a third magnetic body portion disposed on a center portion of the planar inductor,
at least a part of the first magnetic body portion, the second magnetic body portion, and the third magnetic body portion overlap with each other in a normal direction of the substrate,
the first magnetic body portion consists of a first center portion and a plurality of extending portions extending outward from the first center portion in an in-plane direction, or consists of a flat plate portion that covers at least a part of a region from a center of the planar inductor to an outside, and
the second magnetic body portion consists of a second center portion and a plurality of extending portions extending outward from the second center portion in the in-plane direction, or consists of a flat plate portion that covers at least a part of a region from the center of the planar inductor to the outside.

2. The structure according to claim 1,
wherein a magnetic permeability of each of the first magnetic body portion, the second magnetic body portion, and the third magnetic body portion is 1 to 10000 at a frequency of 10 MHz to 500 MHz, 1 to 1000 at a frequency of more than 500 MHz and 10 GHz or less, and 1 to 100 at a frequency of more than 10 GHz and 100 GHz or less.

3. The structure according to claim 1,
wherein a ratio of an area occupied by the third magnetic body portion to an area of an opening portion provided in the center portion of the planar inductor is 25% or more.

4. The structure according to claim 1,
wherein the number of the extending portions of the first magnetic body portion and the number of the extending portions of the second magnetic body portion are each 4 or more.

5. The structure according to claim 1,
wherein at least one of the first magnetic body portion, the second magnetic body portion, or the third magnetic body portion is formed of a composition containing magnetic particles, an alkali-soluble resin, and a polymerizable compound.

6. The structure according to claim 1,
wherein at least one of the first magnetic body portion, the second magnetic body portion, or the third magnetic body portion contains magnetic particles, and the magnetic particles contain at least one metal element of Ni, Co, or Fe and have an average primary particle diameter of 20 to 1000 nm.

7. The structure according to claim 1,
wherein a thickness of each of the first magnetic body portion, the second magnetic body portion, and the third magnetic body portion is 300 μm or less.

8. A method for manufacturing the structure according to claim 1, the method comprising:
a step of applying a photosensitive composition containing magnetic particles onto a substrate to form a composition layer;
a step of subjecting the composition layer to an exposure treatment and a development treatment to form a first magnetic body portion on the substrate;
a step of forming a first insulating layer on the first magnetic body portion;
a step of forming a planar inductor having an opening portion on the first insulating layer;
a step of applying the photosensitive composition onto the planar inductor to form a composition layer, and subjecting the composition layer to an exposure treatment and a development treatment to form a third magnetic body portion in the opening portion of the planar inductor;
a step of forming a second insulating layer on the planar inductor; and
a step of applying the photosensitive composition onto the second insulating layer formed on the planar inductor to form a composition layer, and subjecting the composition layer to an exposure treatment and a development treatment to form a second magnetic body portion.

9. A method for manufacturing the structure according to claim 1, the method comprising:
a step of applying a curable composition containing magnetic particles in a patterned manner onto a substrate to form a first patterned composition layer, and subjecting the first patterned composition layer to a curing treatment to form a first magnetic body portion;
a step of forming a first insulating layer on the first magnetic body portion;
a step of forming a planar inductor having an opening portion on the insulating layer;
a step of applying the curable composition in a patterned manner onto the opening portion of the planar inductor to form a third patterned composition layer, and subjecting the third patterned composition layer to a curing treatment to form a third magnetic body portion;
a step of forming a second insulating layer on the planar inductor; and
a step of applying the curable composition in a patterned manner onto the second insulating layer formed on the planar inductor to form a second patterned composition layer, and subjecting the second patterned composition layer to a curing treatment to form a second magnetic body portion.

10. The method for manufacturing a structure according to claim 8,
wherein the magnetic particles contain at least one metal element of Ni, Co, or Fe and have an average primary particle diameter of 20 to 1000 nm.

11. The structure according to claim 2,
wherein a ratio of an area occupied by the third magnetic body portion to an area of an opening portion provided in the center portion of the planar inductor is 25% or more.

12. The structure according to claim 2,
wherein the number of the extending portions of the first magnetic body portion and the number of the extending portions of the second magnetic body portion are each 4 or more.

13. The structure according to claim 2,
wherein at least one of the first magnetic body portion, the second magnetic body portion, or the third magnetic body portion is formed of a composition containing magnetic particles, an alkali-soluble resin, and a polymerizable compound.

14. The structure according to claim 2,
wherein at least one of the first magnetic body portion, the second magnetic body portion, or the third magnetic body portion contains magnetic particles, and the magnetic particles contain at least one metal element of Ni, Co, or Fe and have an average primary particle diameter of 20 to 1000 nm.

15. The structure according to claim 2,
wherein a thickness of each of the first magnetic body portion, the second magnetic body portion, and the third magnetic body portion is 300 μm or less.

16. A method for manufacturing the structure according to claim 2, the method comprising:
a step of applying a photosensitive composition containing magnetic particles onto a substrate to form a composition layer;
a step of subjecting the composition layer to an exposure treatment and a development treatment to form a first magnetic body portion on the substrate;
a step of forming a first insulating layer on the first magnetic body portion;
a step of forming a planar inductor having an opening portion on the first insulating layer;
a step of applying the photosensitive composition onto the planar inductor to form a composition layer, and subjecting the composition layer to an exposure treatment and a development treatment to form a third magnetic body portion in the opening portion of the planar inductor;
a step of forming a second insulating layer on the planar inductor; and
a step of applying the photosensitive composition onto the second insulating layer formed on the planar inductor to form a composition layer, and subjecting the composition layer to an exposure treatment and a development treatment to form a second magnetic body portion.

17. A method for manufacturing the structure according to claim 2, the method comprising:
a step of applying a curable composition containing magnetic particles in a patterned manner onto a substrate to form a first patterned composition layer, and subjecting the first patterned composition layer to a curing treatment to form a first magnetic body portion;
a step of forming a first insulating layer on the first magnetic body portion;
a step of forming a planar inductor having an opening portion on the insulating layer;
a step of applying the curable composition in a patterned manner onto the opening portion of the planar inductor to form a third patterned composition layer, and subjecting the third patterned composition layer to a curing treatment to form a third magnetic body portion;
a step of forming a second insulating layer on the planar inductor; and
a step of applying the curable composition in a patterned manner onto the second insulating layer formed on the planar inductor to form a second patterned composition layer, and subjecting the second patterned composition layer to a curing treatment to form a second magnetic body portion.

18. The method for manufacturing a structure according to claim 9,
wherein the magnetic particles contain at least one metal element of Ni, Co, or Fe and have an average primary particle diameter of 20 to 1000 nm.

19. The structure according to claim 3,
wherein the number of the extending portions of the first magnetic body portion and the number of the extending portions of the second magnetic body portion are each 4 or more.

20. The structure according to claim 3,
wherein at least one of the first magnetic body portion, the second magnetic body portion, or the third magnetic body portion is formed of a composition containing magnetic particles, an alkali-soluble resin, and a polymerizable compound.
